(19) United States
(12) Patent Application Publication
(10) Pub. No.: US 2019/0302657 A1
(43) Pub. Date: Oct. 3, 2019

(54) IMAGE FORMING APPARATUS

(71) Applicant: CANON KABUSHIKI KAISHA, Tokyo (JP)

(72) Inventor: Kiyoshi Oyama, Tokyo (JP)

(21) Appl. No.: 16/357,437

(22) Filed: Mar. 19, 2019

(30) Foreign Application Priority Data
Mar. 27, 2018 (JP) 2018-060696

(51) Int. Cl. G03G 15/16

(52) U.S. Cl. CPC G03G 15/1675; G03G 2215/0119; G03G 15/1655; G03G 15/1615

(57) ABSTRACT

An image forming apparatus includes a rotatable belt member, a first stretch roller, a second stretch roller, a rotary member, a conveyance roller, a pressing member, a driving source, and a control unit. The pressing member moves between a first position and a second position at which the pressing member projects to a conveyance path of the recording material than the first position. The driving source drives the pressing member. The control unit controls the driving source such that the pressing member is positioned at the first position if a basis weight of the recording material conveyed to the transfer nip portion is equal to or smaller than a predetermined value and the pressing member is positioned at the second position if the basis weight of the recording material conveyed to the transfer nip portion is greater than the predetermined value.

### BACKGROUND OF THE INVENTION

### Field of the Invention

The present invention relates to an image forming apparatus such as a copying machine, a printer, a facsimile device and the like that adopts an electrophotographic system or an electrostatic recording system.

### Description of the Related Art

Hitherto, an image forming apparatus of an electrophotographic system is known that adopts a method where toner image formed on an image bearing member such as a photosensitive drum is primarily transferred to an intermediate transfer member, and thereafter, the primarily transferred toner image is secondarily transferred to a sheet serving as a recording medium. This type of image forming apparatus uses an intermediate transfer belt as an intermediate transfer member, and toner image is transferred to the sheet at a transfer nip portion formed between the intermediate transfer belt and a transfer roller. In this type of image forming apparatus, a problem is known where impact occurs when the sheet conveyed to the intermediate transfer belt or the transfer nip portion enters and passes the same, and image is disturbed by the impact and quality of the product is deteriorated. Various proposals have been made as techniques to reduce such impact by moving a guide member that guides the sheet to the transfer nip portion.

An image forming apparatus is known, as disclosed in Japanese Patent Application Laid-Open Publication No. 2012-185454, in which a pair of guide members for guiding a sheet to a transfer nip portion is arranged in an opposite manner and one of the guide members, i.e., swing guide member, arranged on an intermediate transfer belt side is designed to move in swinging motion. According to this image forming apparatus, when a leading edge of a sheet enters the transfer nip portion, the swing guide member is positioned in a direction oriented along the intermediate transfer belt to suppress impact that occurs when the leading edge of the sheet abuts against the intermediate transfer belt. Further, when a trailing edge of the exists the swing guide member, the swing guide member is positioned so as to push the trailing edge of the sheet outward from the intermediate transfer belt side to prevent the trailing edge of the sheet from bouncing on the intermediate transfer belt when being released from the swing guide member.

Further, an image forming apparatus is known, as disclosed in Japanese Patent Application Laid-Open Publication No. 2015-31897, in which two guide members for guiding a sheet to a transfer nip portion is arranged side by side in a conveyance direction, each of the two guide members formed movably and swingably. According to this image forming apparatus, respective guide members are moved and swung in response to sheet type to form an appropriate conveyance path for each sheet type. For example, if a sheet having a high stiffness is conveyed, the respective guide members are moved upstream and swung to reduce the angle formed by the guide members, thereby forming a conveyance path that allows the sheet to move as straight as possible. If a sheet having a low stiffness is conveyed, the respective guide members are moved downstream and swung to increase the angle formed by the guide members, thereby forming a conveyance path that allows the sheet to be conveyed toward the transfer nip portion at a vicinity of the transfer nip portion.

In order to minimize the impact that occurs when the leading edge of a sheet enters the transfer nip portion, it is preferable that the sheet enters the transfer nip portion at an angle that is as small as possible with respect to a nip line of the transfer nip portion. The nip line of the transfer nip portion refers to a line that passes the transfer nip portion and that is perpendicular to a straight line connecting respective centers of a roller pair that forms the transfer nip portion. In other words, it is preferable to have the sheet enter the transfer nip portion from a vicinity of the intermediate transfer belt on an upstream side of the transfer nip portion in the sheet conveyance direction. However, since a conveyance mechanism that conveys the sheet to the transfer nip portion must be arranged so as not to interfere with the intermediate transfer belt, the conveyance path from the conveyance mechanism to the transfer nip portion is inevitably curved. If there is an extreme curved portion in the conveyance path, jamming of sheets becomes a problem. Especially if the sheet is a thin sheet having low stiffness, sheet jamming tends to occur at the curved portion. Therefore, if a curved portion is formed on the conveyance path with the aim to suppress shock that occurs when a thick paper enters the transfer nip portion, risk of conveyance failure of thin paper increases. Therefore, it was difficult to realize both suppression of shock during entry of thick paper to the transfer portion and suppression of conveyance failure of thin paper.

However, according to the image forming apparatus disclosed in above-described Japanese Patent Application Laid-Open Publication No. 2012-185454, the swing guide member is positioned along the intermediate transfer belt when the leading edge of the sheet enters the transfer nip portion, regardless of the stiffness of the sheet. Therefore, the conveyance path is curved greatly even when thin paper is conveyed, which may cause conveyance failure of the thin paper. Further, according to the image forming apparatus disclosed in above-described Japanese Patent Application Laid-Open Publication No. 2015-31897, a conveyance path close to a straight line is formed to minimize conveyance resistance when conveying a sheet having a high stiffness, such as thick paper. Therefore, the direction of entry of the sheet to the transfer nip portion may deviate greatly from the direction along the intermediate transfer belt and inclination of the direction of entry of the sheet to the transfer nip portion with respect to the intermediate transfer belt may be increased, by which the impact generated when the leading edge of the sheet enters the transfer nip portion may become greater. Furthermore, the conveyance path is curved if a sheet such as thin paper having a low stiffness is conveyed. However, a sheet having a low stiffness such as thin paper tends to be bent at the curved portion and may cause sheet jamming. It was difficult to realize both suppression of occurrence of impact at the transfer nip portion when conveying thick paper and suppression of sheet jamming when conveying thin paper.

The present invention provides an image forming apparatus capable of realizing both suppression of occurrence of impact at the transfer nip portion when conveying a sheet such as thick paper having a high stiffness and suppression of sheet jamming when conveying a sheet such as thin paper having a low stiffness.

### SUMMARY OF THE INVENTION

According to one aspect of the present invention, an image forming apparatus includes a rotatable belt member configured to bear a toner image, a first stretch roller configured to stretch the belt member, a second stretch roller configured to stretch the belt member at a position adjacent to the first stretch roller on an upstream side in a direction of rotation of the belt member, a rotary member that is in contact with an outer circumferential surface of the belt member, the rotary member configured to nip the belt member with the first stretch roller and form a transfer nip portion where toner image is transferred from the belt member to a recording material while conveying the recording material between the belt member and the rotary member, a conveyance roller that is arranged upstream of the transfer nip portion in a conveyance direction of the recording material, the conveyance roller configured to form a conveyance nip portion that conveys the recording material and delivers the recording material to the transfer nip portion, a pressing member positioned upstream of the transfer nip portion in the conveyance direction and downstream of the conveyance nip portion in the conveyance direction, the pressing member configured to move between a first position and a second position, the second position at which the pressing member projects to a conveyance path of the recording material than the first position and presses a first surface of the recording material opposed to a second surface of the recording material facing the belt member, a driving source configured to drive the pressing member, and a control unit configured to control the driving source. The control unit controls the driving source such that the pressing member is positioned at the first position if a basis weight of the recording material conveyed to the transfer nip portion is equal to or smaller than a predetermined value and the pressing member is positioned at the second position if the basis weight of the recording material conveyed to the transfer nip portion is greater than the predetermined value.

Further features of the present invention will become apparent from the following description of exemplary embodiments with reference to the attached drawings.

### BRIEF DESCRIPTION OF THE DRAWINGS

FIG. 1 is a cross-sectional view illustrating a general configuration of an image forming apparatus according to a first embodiment.

FIG. 2 is a control block diagram illustrating a control system of an image forming apparatus according to the first embodiment.

FIG. 3A is a cross-sectional view illustrating a general configuration of a sheet conveyance path from a registration roller to a transfer nip portion of the image forming apparatus according to the first embodiment, wherein an outer downstream guide is positioned at a first position.

FIG. 3B is a cross-sectional view illustrating a general configuration of a sheet conveyance path from the registration roller to the transfer nip portion of the image forming apparatus according to the first embodiment, wherein the outer downstream guide is positioned at a second position.

FIG. 4 is a schematic view illustrating a simulation model of the sheet conveyance path from the registration roller to the transfer nip portion of the image forming apparatus according to the first embodiment.

FIG. 5A is a schematic view illustrating a simulation model of the image forming apparatus according to the first embodiment, wherein a downstream edge portion of a sheet is abutted against an inner downstream guide.

FIG. 5B is a schematic view illustrating a simulation model of the image forming apparatus according to the first embodiment, wherein the outer downstream guide is moved to the second position.

FIG. 6A is a schematic view illustrating a simulation model of the image forming apparatus according to the first embodiment, wherein the downstream edge portion of the sheet is guided to a position immediately before the transfer nip portion.

FIG. 6B is a schematic view illustrating a simulation model of the image forming apparatus according to the first embodiment, wherein the downstream edge portion of the sheet is nipped by the transfer nip portion.

FIG. 7 is a graph illustrating a time variation of speed of the intermediate transfer belt in the simulation model of the image forming apparatus according to the first embodiment.

FIG. 8A is a schematic view illustrating a simulation model of the image forming apparatus according to the first embodiment, illustrating a timing where the downstream edge portion of the sheet is positioned immediately before abutment with the intermediate transfer belt.

FIG. 8B is a schematic view illustrating a simulation model of the image forming apparatus according to the first embodiment, wherein the downstream edge portion of the sheet is guided to the position immediately before the transfer nip portion.

FIG. 9A is a schematic view illustrating a simulation model of the image forming apparatus according to the first embodiment, wherein the downstream edge portion of the sheet is nipped by the transfer nip portion.

FIG. 9B is a schematic view illustrating a simulation model of the image forming apparatus according to the first embodiment, wherein the downstream edge portion of the sheet is passed through the transfer nip portion.

FIG. 10A is a schematic view illustrating a simulation model of the image forming apparatus according to the first embodiment, wherein the downstream edge portion of the sheet is abutted against the inner downstream guide.

FIG. 10B is a schematic view illustrating a simulation model of the image forming apparatus according to the first embodiment, wherein bending of the sheet has started.

FIG. 11A is a schematic view illustrating a simulation model of the image forming apparatus according to the first embodiment, wherein the downstream edge portion of the sheet has been guided to the position immediately before the transfer nip portion.

FIG. 11B is a schematic view illustrating a simulation model of the image forming apparatus according to the first embodiment, wherein the downstream edge portion of the sheet is nipped by the transfer nip portion.

FIG. 12 is a graph illustrating a time variation of load torque of the registration roller in the simulation model of the image forming apparatus according to the first embodiment.

FIG. 13A is a cross-sectional view illustrating a general configuration of a sheet conveyance path from a registration roller to a transfer nip portion according to an image forming apparatus of a second embodiment, wherein an outer downstream guide is positioned at a first position.

FIG. 13B is a cross-sectional view illustrating a general configuration of the sheet conveyance path from the registration roller to the transfer nip portion according to the image forming apparatus of the second embodiment, wherein the outer downstream guide is positioned at a second position.

FIG. 14A is a schematic view illustrating a simulation model of the image forming apparatus according to the second embodiment, wherein a downstream edge portion of the sheet is abutted against an intermediate transfer belt.

FIG. 14B is a schematic view illustrating the simulation model of the image forming apparatus according to the second embodiment, wherein the outer downstream guide has been moved to the second position.

FIG. 15A is a schematic view illustrating the simulation model of the image forming apparatus according to the second embodiment, wherein the downstream edge portion of the sheet has been guided to a position immediately before the transfer nip portion.

FIG. 15B is a schematic view illustrating the simulation model of the image forming apparatus according to the second embodiment, wherein the downstream edge portion of the sheet has been nipped by the transfer nip portion.

FIG. 16 is a graph illustrating a time variation of speed of the intermediate transfer belt in the simulation model of the image forming apparatus according to the second embodiment.

FIG. 17A is a schematic view illustrating a simulation model of the image forming apparatus according to the second embodiment, wherein the downstream edge portion of the sheet has been abutted against the intermediate transfer belt.

FIG. 17B is a schematic view illustrating the simulation model of the image forming apparatus according to the second embodiment, wherein bending of the sheet has started.

FIG. 18A is a schematic view illustrating the simulation model of the image forming apparatus according to the second embodiment, wherein the downstream edge portion of the sheet has been guided to the position immediately before the transfer nip portion.

FIG. 18B is a schematic view illustrating the simulation model of the image forming apparatus according to the second embodiment, wherein the downstream edge portion of the sheet has been nipped by the transfer nip portion.

FIG. 19 is a graph illustrating a time variation of load torque of a registration roller in the simulation model of the image forming apparatus according to the second embodiment.

FIG. 20 is a cross-sectional view illustrating a general configuration of an image forming apparatus according to a third embodiment.

FIG. 21 is a cross-sectional view illustrating a general configuration of a sheet conveyance path from a registration roller to a transfer nip portion of the image forming apparatus according to the third embodiment.

### DESCRIPTION OF THE EMBODIMENTS

### First Embodiment

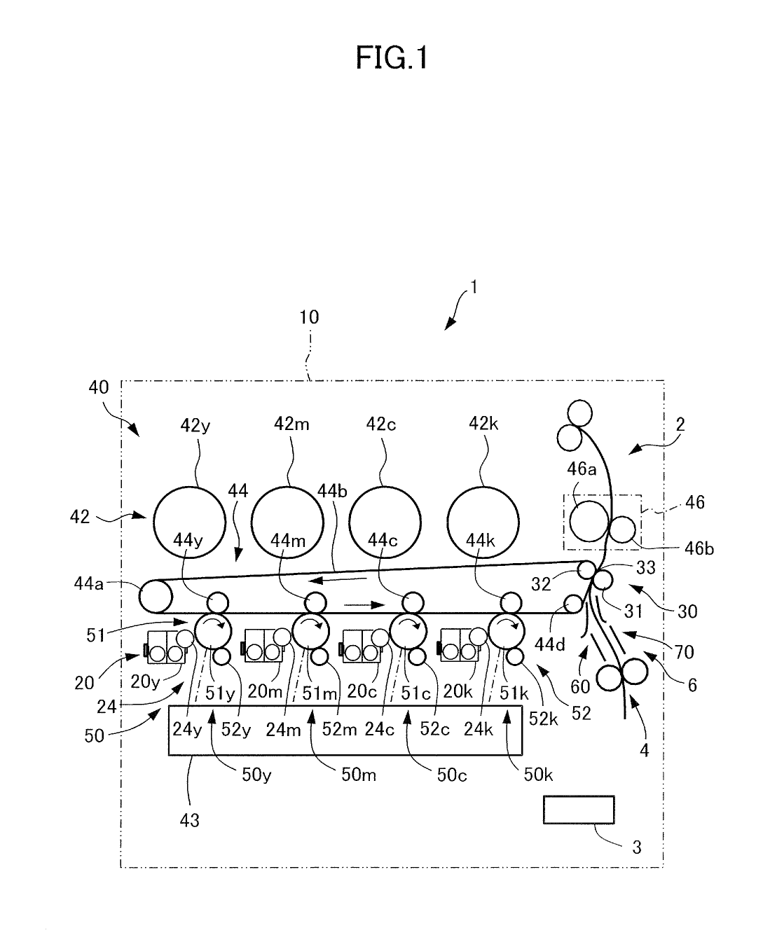

Now, a first embodiment of the present invention will be described in detail with reference to FIGS. 1 through 12. In the present embodiment, a tandem-type full color printer is described as an example of an image forming apparatus 1. However, the present invention is not restricted to the tandem-type image forming apparatus 1, and it can be adopted to other types of image forming apparatuses which not only is full-color but also monochrome or mono-color. Further, the present invention can be implemented in devices used for various purposes, such as a printer, various printing machines, a copying machine, a facsimile, a multifunction machine and so on. In the present embodiment, a two-component developer containing nonmagnetic toner and magnetic carrier is used as developer.

As illustrated in FIG. 1, the image forming apparatus 1 includes an image forming apparatus body, hereinafter referred to as apparatus body, 10. The apparatus body 10 includes an image reading unit and a sheet conveyance unit not shown, an image forming unit 40, a sheet conveyance unit 2, a sheet discharge portion not shown, and a control unit 3. The image forming apparatus 1 can form a four-color full-color image on a recording material based on image signals from an image reading unit, a host device such as a personal computer or an external device such as a digital camera or a smartphone. Actual examples of the sheet serving as the recording material on which a toner image is formed include normal paper, resin sheets as substitute for normal paper, thick paper, OHP sheets and so on. In the present embodiment, thick paper is defined as a recording material having a basis weight that is greater than a predetermined value, such as a recording material having a basis weight that exceeds 300 g/m².

The image forming unit 40 includes a drum cartridge 50, a developing apparatus 20, a toner container 42, a laser scanner 43, an intermediate transfer unit 44, a secondary transfer portion 30 and a fixing unit 46. The image forming unit 40 can form an image on a sheet fed from a registration roller pair 4 of the sheet conveyance unit based on image information. The image forming apparatus 1 according to the present embodiment corresponds to full-color image, and includes drum cartridges 50y, 50m, 50c and 50k corresponding to yellow (y), magenta (m), cyan (c) and black (k), which have the same configuration and are disposed independently. Similarly, toner containers 42y, 42m, 42c and 42k also correspond to yellow (y), magenta (m), cyan (c) and black (k), which have the same configuration and are disposed independently. Therefore, identifiers corresponding to the respective colors are added to the end of reference numbers for the respective components of four colors in FIG. 1, but in the specification, the description may not have the identifiers corresponding to colors added to reference numbers.

The toner container 42 is a cylindrical bottle in which toner is stored, for example, and arranged above each drum cartridge 50 via a toner hopper. The laser scanner 43 exposes a surface of a photosensitive drum 51 charged by a charge roller 52 and forms an electrostatic latent image on the surface of the photosensitive drum 51.

The drum cartridge 50 is a photosensitive unit formed as a unit and attached detachably to the apparatus body 10. The drum cartridge 50 includes a photosensitive drum, i.e., image bearing member, 51 capable of bearing a toner image and rotating, a charge roller 52 and a cleaning blade not shown. The photosensitive drum 51, the charge roller 52, the developing apparatus 20 and a developing sleeve 24 are also provided independently and having the same configuration for each of the four colors of yellow (y), magenta (m), cyan (c) and black (k).

The photosensitive drum 51 includes a photosensitive layer formed to have negative charged polarity on a surface of an outer circumference of an aluminum cylinder, and the photosensitive drum 51 rotates at a predetermined processing speed, i.e., peripheral speed. The charge roller 52 contacts the surface of the photosensitive drum 51 and charges the surface of the photosensitive drum 51 to a uniform negative dark potential, for example. After charging the surface of the photosensitive drum 51, an electrostatic latent image is formed based on image information using the laser scanner 43. The photosensitive drum 51 bears the electrostatic latent image being formed and rotates, and the image is developed using toner by the developing sleeve 24 of the developing apparatus 20. The developed toner image is primarily transferred to an intermediate transfer belt 44b described later. The surface of the photosensitive drum 51 after primary transfer is destaticized by a pre-exposure unit not shown.

The intermediate transfer unit 44 is arranged above the drum cartridges 50y, 50m, 50c and 50k. The intermediate transfer unit 44 includes a plurality of rollers such as a drive roller 44a, a driven roller, serving as a second stretch roller, 44d, and a plurality of primary transfer rollers 44y, 44m, 44c and 44k, and an intermediate transfer belt, serving as a belt member, 44b that is wound around the rollers and capable of rotating. The driven roller 44d stretches the intermediate transfer belt 44b at a position adjacent to a secondary transfer inner roller 32 described later on an upstream side in a rotation direction of the intermediate transfer belt 44b. In the present embodiment, the secondary transfer inner roller 32 is arranged at a position projected larger than the driven roller 44d with respect to a direction in which the secondary transfer inner roller 32 presses the intermediate transfer belt 44b horizontally.

The portion stretched between the secondary transfer inner roller 32 and the driven roller 44d of the intermediate transfer belt 44b is referred to as a flat portion, i.e., stretched portion, 44f. The primary transfer rollers 44y, 44m, 44c and 44k are arranged opposed to the photosensitive drums 51y, 51m, 51c and 51k, respectively, abutting against the intermediate transfer belt 44b and primarily transferring toner images formed on the photosensitive drums 51 to the intermediate transfer belt 44b. Primary transfer bias is applied to the intermediate transfer belt 44b, by which toner images formed on the photosensitive drums 51 are primarily transferred at the primary transfer portion. The intermediate transfer belt 44b is capable of bearing toner image and rotating.

The intermediate transfer belt 44b is an endless belt having a three-layer structure composed, from an inner side, of a resin layer, an elastic layer and a surface layer. The resin layer has a thickness of 70 to 100 μm and is composed of resin material such as polyimide and polycarbonate. The elastic layer has a thickness of 200 to 250 μm and is composed of elastic material such as urethane rubber and chloroprene rubber. The surface layer has a thickness of 5 to 10 μm and is composed of material that reduces adhesion force of toner to the surface of the intermediate transfer belt 44b and facilitates transfer of toner to the sheet at a transfer nip portion 33 of the secondary transfer portion 30. Specifically, one type of resin material, such as polyurethane, polyester or epoxy resin, can be used. In another example, a material that reduces surface energy and improves lubricity, such as powder or particles of fluororesin, dispersed in elastic material, such as elastic rubber or elastomer, can be used.

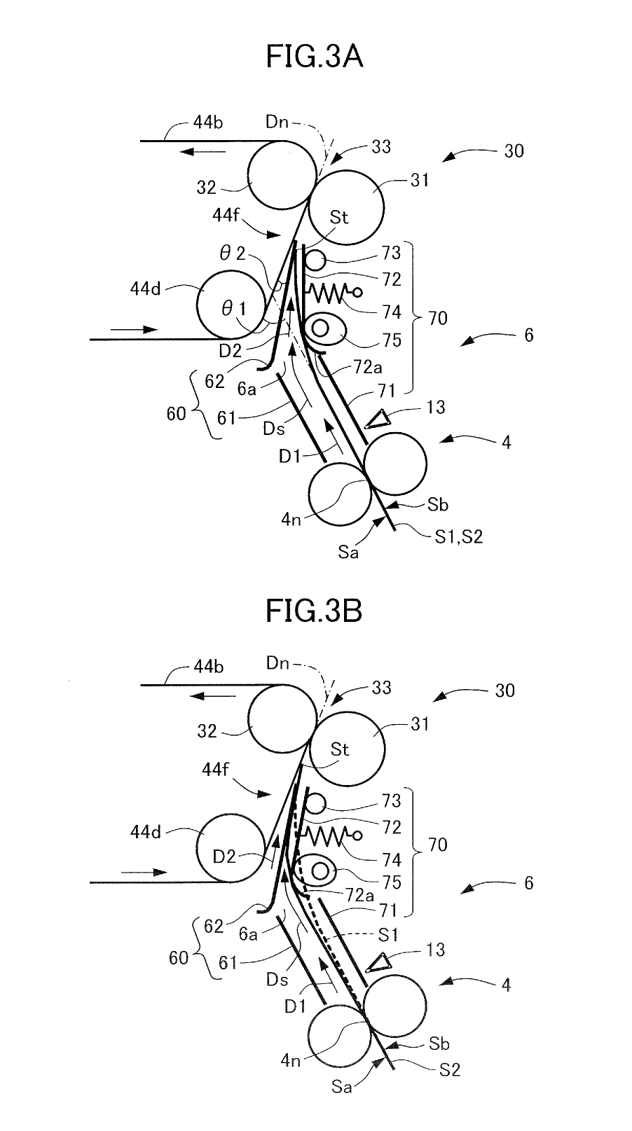

The secondary transfer portion 30 includes a secondary transfer outer roller, serving as roller, 31 and a secondary transfer inner roller, serving as first stretch roller, 32. The secondary transfer portion 30 secondarily transfers the toner image on the intermediate transfer belt 44b to a sheet by having secondary transfer bias applied at the transfer nip portion 33 formed by the secondary transfer outer roller 31 and the intermediate transfer belt 44b. The secondary transfer outer roller 31 forms the transfer nip portion 33 that conveys the sheet with the intermediate transfer belt 44b and where toner image is transferred from the intermediate transfer belt 44b to the sheet. The secondary transfer outer roller 31 constitutes an elastic layer formed of rubber or sponge for forming the transfer nip portion 33. The secondary transfer inner roller 32 is provided on an inner circumferential side of the intermediate transfer belt 44b and holds the intermediate transfer belt 44b in a stretched manner with the secondary transfer outer roller 31. In the present embodiment, by having DC voltage of positive polarity applied to the secondary transfer outer roller 31 from a power supply not shown, the secondary transfer portion 30 forms a transfer electric field of toner image as secondary transfer bias between the secondary transfer outer roller 31 and the secondary transfer inner roller 32 being connected to ground potential. The direction of discharge of the sheet conveyed from the transfer nip portion 33 is a nip line direction Dn of the intermediate transfer belt 44b and the secondary transfer outer roller 31 (refer to FIG. 3A). The configuration for conveying the sheet to the secondary transfer portion 30 will be described later.

The fixing unit 46 includes a fixing roller 46a and a pressure roller 46b, and by nipping and conveying a sheet between the fixing roller 46a and the pressure roller 46b, the toner image transferred to the sheet is heated, pressed and fixed to the sheet.

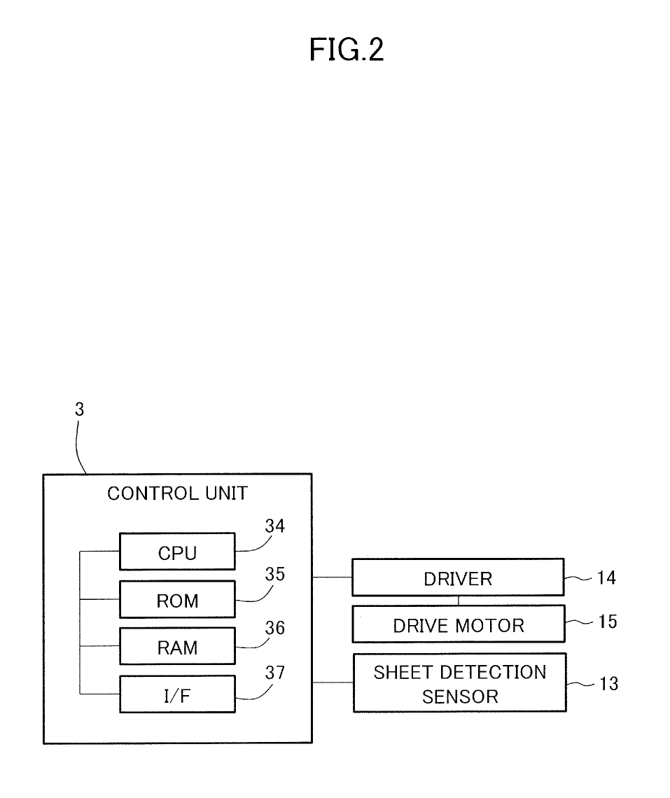

As illustrated in FIG. 2, a control unit 3 is composed of a computer and constitutes an executing unit. The control unit 3 includes, for example, a CPU 34, a ROM 35 storing programs for controlling various units, a RAM 36 storing data temporarily, and an input/output circuit (I/F) 37 that inputs/outputs signals with an exterior. The CPU 34 is a microprocessor that administers the overall control of the image forming apparatus 1, and it is a main part of a system controller. The CPU 34 is connected through the input/output circuit 37 to the image reading unit, the sheet conveyance unit, the image forming unit 40, the sheet conveyance unit 2, an operation unit, a sheet detection sensor 13 and a driver 14, the CPU 34 communicating signals with respective units and controlling operation. The driver 14 is connected to a drive motor 15 that drives an eccentric cam 75 described later. In other words, the control unit 3 controls the drive motor 15 serving as driving source described later and the eccentric cam 75 through the driver 14.

Next, an image forming operation according the image forming apparatus 1 having the above-described configuration will be described. In a state where the image forming operation is started, the photosensitive drum 51 rotates and the surface thereof is charged by a charge roller 52. Then, laser beam is irradiated to the photosensitive drum 51 from the laser scanner 43 based on image information, and electrostatic latent image is formed on the surface of the photosensitive drum 51. The electrostatic latent image is developed by toner by the developing apparatus 20 and visualized as toner image, and the toner image is transferred to the intermediate transfer belt 44b.

Meanwhile, in parallel with the toner image forming operation, the sheet conveyance unit is activated and the sheet is conveyed to the secondary transfer portion 30 by the registration roller pair 4 at a matched timing with the toner image on the intermediate transfer belt 44b. Toner image is transferred from the intermediate transfer belt 44b to the sheet and the sheet is conveyed to the fixing unit 46, where unfixed toner image is heated and pressed and fixed to the surface of the sheet, and then the sheet is discharged from the apparatus body 10.

Next, a configuration for conveying the sheet to the secondary transfer portion 30 will be described in detail with reference to FIGS. 3A and 3B. According to the present embodiment, the secondary transfer portion 30 adopts a vertical path system in which the sheet is conveyed upward from below. In the drawing, sheet S2 illustrates a sheet in a state where thick paper mode is executed, and sheet S1 illustrates a sheet in a state where thick paper mode is not executed. That is, sheet S2 illustrates the sheet conveyed while executing the thick paper mode where an outer downstream guide 72 has been moved, and sheet S1 illustrates the sheet conveyed without executing the thick paper mode where the outer downstream guide 72 is fixed to the second position.

As illustrated in FIG. 3A and FIG. 3B, on an upstream side in a sheet conveyance direction Ds of the secondary transfer portion 30, a conveyance nip portion 4n that conveys sheets is formed and a pair of registration rollers, i.e., conveyance rollers, 4 for delivering sheets to the transfer nip portion 33 is arranged. The registration roller pair 4 receives sheets S1 and S2 in a stopped state to correct skewing and starts rotating at a predetermined timing to feed sheets S1 and S2 to the secondary transfer portion 30. The registration roller pair 4 conveys sheets S1 and S2 to a first direction D1, whose angle formed with the nip line direction Dn is a first angle θ1 at an upstream side in a sheet conveyance direction Ds of the transfer nip portion 33. Further, a sheet detection sensor 13 that detects whether sheet S1 or S2 is conveyed in the conveyance path is provided in the vicinity of the registration roller pair 4. The sheet detection sensor 13 is formed of a photosensor, for example, capable of detecting whether a downstream edge portion, i.e., a leading edge portion, St of sheet S1 or S2 has passed the vicinity of the registration roller pair 4.

A sheet guide mechanism 6 that guides sheet S1 or S2 conveyed from the registration roller pair 4 to the secondary transfer portion 30 is provided between the registration roller pair 4 and the secondary transfer portion 30. The sheet guide mechanism 6 includes an inner guide portion 60 and an outer guide portion 70 that are arranged opposed to one another. The inner guide portion 60 is disposed at a side close to the intermediate transfer belt 44b than the outer guide portion 70. The outer guide portion 70 is provided on a side more distant from the intermediate transfer belt 44b than the inner guide portion 60.

The inner guide portion 60 includes an inner upstream guide 61 and an inner downstream guide, i.e., guide member, 62 arranged continuously along the sheet conveyance path. The inner upstream guide 61 is approximately plate shaped and arranged upstream of the inner downstream guide 62 in the sheet conveyance direction Ds. The inner downstream guide 62 is arranged downstream of the inner upstream guide 61 in the sheet conveyance direction Ds, and a surface of the inner downstream guide 62 opposite to the conveyance surface is arranged to face the intermediate transfer belt 44b. The intermediate transfer belt 44b has a flat, planar portion 44f stretched across the secondary transfer inner roller 32 and the driven roller 44d. The inner downstream guide 62 is approximately plate shaped and arranged along the planar portion 44f of the intermediate transfer belt 44b, and the inner downstream guide 62 is arranged in an inclined manner with respect to the planar portion 44f such that the transfer nip portion 33 side approximates the planar portion 44f. The inner downstream guide 62 is arranged so that a downstream edge portion in the sheet conveyance direction Ds contacts the planar portion 44f arranged upstream of the transfer nip portion 33 before reaching the transfer nip portion 33.

The inner downstream guide 62 guides the sheets S1 and S2 in a second direction D2 by having the sheet S1 or S2 conveyed by the registration roller pair 4 abut against the inner downstream guide 62 at an upstream side of the transfer nip portion 33 in the sheet conveyance direction Ds. The second direction D2 is a direction where the angle formed between the nip line direction Dn is a second angle θ2, and the second angle θ2 is set smaller than the first angle θ1 of the first direction D1 in which the sheets S1 and S2 are conveyed by the registration roller pair 4. That is, the inner downstream guide 62 is arranged upstream of the transfer nip portion 33 in the sheet conveyance direction Ds and downstream of the conveyance nip portion 4n in the sheet conveyance direction Ds. By having a transfer surface Sa of the sheet S on which toner is transferred abut against the inner downstream guide 62, the inner downstream guide 62 guides the sheet S to the planar portion 44f of the intermediate transfer belt 44b. In other words, the inner downstream guide 62 guides the sheet S to the intermediate transfer belt 44b by having the transfer surface Sa of the sheet S which opposes to the intermediate transfer belt 44b abut against the inner downstream guide 62.

The outer guide portion 70 includes an outer upstream guide 71 and an outer downstream guide, serving as pressing member, 72 which are arranged continuously along the sheet conveyance path. The outer upstream guide 71 is approximately plate shaped and arranged upstream of the outer downstream guide 72 in the sheet conveyance direction Ds, opposing to the inner upstream guide 61. The inner upstream guide 61, the inner downstream guide 62 and the outer upstream guide 71, excluding the outer downstream guide 72, are arranged in a fixed manner with respect to the apparatus body 10.

The sheet guide mechanism 6 includes, at an intermediate portion in the sheet conveyance direction Ds, a curved portion 6a that changes paths from the conveyance direction of the registration roller pair 4, i.e., first direction D1, to the conveyance direction of the secondary transfer portion 30, i.e., second direction D2, that is, a direction along the planar portion 44f of the intermediate transfer belt 44b. The curved portion 6a is positioned in the vicinity of a joint between the inner upstream guide 61 and the inner downstream guide 62, and a joint between the outer upstream guide 71 and the outer downstream guide 72.

In the present embodiment, when viewed from a rotational axis direction of the registration roller pair 4 as illustrated in FIG. 3A, a nip line direction at the conveyance nip portion 4n toward a downstream side in the sheet conveyance direction Ds, i.e., conveyance nip line, is inclined from a vertical direction toward a side in which the intermediate transfer belt 44b. That is, in FIG. 3A, the first direction D1, which is the sheet conveyance direction Ds at the conveyance nip portion 4n, is inclined to a counterclockwise direction with respect to the vertical direction. Meanwhile, the nip line direction Dn toward the downstream side in the sheet conveyance direction Ds at the transfer nip portion 33, is inclined to the side without the intermediate transfer belt 44b with respect to the vertical direction, that is, to an opposite side from the side having the intermediate transfer belt 44b. That is, in FIG. 3A, the nip line direction Dn which is the sheet conveyance direction Ds in the transfer nip portion 33 is tilted in the clockwise direction with respect to the vertical direction. Therefore, the sheet is conveyed while forming an S-shaped curve while passing through a sheet conveyance unit not shown via the registration roller pair 4 to the transfer nip portion 33. If a sheet having high stiffness such as thick paper is conveyed, the shock that occurs when the sheet enters the transfer nip portion 33 is great. Therefore, according to the present embodiment, the outer downstream guide 72 is disposed in a movable manner.

The outer downstream guide 72 serving as the pressing member is approximately plate shaped and arranged downstream of the outer upstream guide 71 in the sheet conveyance direction Ds. The outer downstream guide 72 is arranged upstream of the transfer nip portion 33 in the sheet conveyance direction Ds and downstream of the conveyance nip portion 4n in the sheet conveyance direction Ds and arranged to oppose to at least a portion of the inner downstream guide 62. The outer downstream guide 72 is a swing member configured swingably about a swing shaft 73 disposed along the rotational axis direction of each roller of the registration roller pair 4, and the outer downstream guide 72 is urged by an eccentric cam 75 via a tension coil spring 74 composed for example of a torsion coil spring and retained in a state abutted against the eccentric cam 75. The outer downstream guide 72 includes a pressure edge portion 72a that is curved to an outer side in the sheet conveyance path at an upstream side in the sheet conveyance direction Ds.

The outer downstream guide 72 is rotatable about the swing shaft 73 between a first position and a second position that is closer to the inner downstream guide 62 than the first position by the rotation of the eccentric cam 75. That is, the outer downstream guide 72 is capable of moving to the first position and the second position by swinging motion. The outer downstream guide 72 is positioned closer to the driven roller 44d when it is positioned at the second position than at the first position. That is, in a state where the outer downstream guide 72 is positioned at the first position, the distance from the driven roller 44d is a first distance, and in a state where it is positioned at the second position, the distance from the driven roller 44d is a second distance that is shorter than the first distance. The eccentric cam 75 is driven to rotate by the drive motor 15 such as a stepping motor (refer to FIG. 2). The drive motor 15 and the eccentric cam 75 constitute the driving source that drives the outer downstream guide 72.

As illustrated in FIG. 3A, the curved portion 6a of the outer downstream guide 72 has a shallow curve at the first position, and as illustrated in FIG. 3B, the curved portion 6a has a deeper curve at the second position. In FIG. 3B, the shape of the sheet S1 having a shallow curve according to FIG. 3A is illustrated by a broken line. As illustrated in FIGS. 3A and 3B, sheet S1 or S2 is conveyed from the registration roller pair 4, and after the downstream edge portion of the sheet has been abutted against the inner downstream guide 62, a portion of the sheet S1 or S2 contacts the pressure edge portion 72a. Thereby, the sheet S1 or S2 is retained by the registration roller pair 4 and the inner downstream guide 62, contacted by the pressure edge portion 72a therebetween and curved. That is, the outer downstream guide 72 forms a conveyance path with the inner downstream guide 62 through which the sheets are conveyed, and it is movable between a first position and a second position, the second position entering the conveyance path formed by the outer downstream guide 72 positioned at the first position and pressing a surface Sb of the sheet opposite to the transfer surface Sa. The opposite surface Sb is a rear surface of the transfer surface Sa of the sheet that faces the intermediate transfer belt 44b. The outer downstream guide 72 is composed movably at a position that is not in contact with the intermediate transfer belt 44b. That is, if the outer downstream guide 72 is at a second position, it is capable of pressing the sheet being conveyed but the outer downstream guide 72 does not press the intermediate transfer belt 44b.

As illustrated in FIG. 3A, when the pressure edge portion 72a is positioned at the first position, the sheet S2 is conveyed without being curved greatly. In contrast, as illustrated in FIG. 3B, when the pressure edge portion 72a is positioned at the second position, the sheet S2 is pressed by the pressure edge portion 72a toward the inner downstream guide 62 and curved greatly along the pressure edge portion 72a. Therefore, when the outer downstream guide 72 is positioned at the second position, the leading edge of the sheet S2 enters the transfer nip portion 33 in a state where the sheet S2 is positioned further along the planar portion 44f of the intermediate transfer belt 44b than when the outer downstream guide 72 is positioned at the first position.

If basis weight of the sheet conveyed to the transfer nip portion 33 is equal to or smaller than a predetermined value, the control unit 3 controls the driving source so that the position of the outer downstream guide 72 is positioned at the first position. If basis weight of the sheet conveyed to the transfer nip portion 33 is greater than the predetermined value, the control unit 3 controls the driving source so that the outer downstream guide 72 is positioned at the second position. Further according to the present embodiment, if basis weight of the sheet conveyed to the transfer nip portion 33 is greater than the predetermined value, the control unit 3 controls the driving source so that the outer downstream guide 72 is positioned at the first position before the downstream edge portion St of the sheet reaches the outer downstream guide 72. Further, if basis weight of the sheet conveyed to the transfer nip portion 33 is greater than the predetermined value, the control unit 3 controls the driving source so that the outer downstream guide 72 is positioned at the second position after the downstream edge portion St of the sheet has reached the outer downstream guide 72 and before the downstream edge portion St reaches the transfer nip portion 33. Also, if basis weight of the sheet conveyed to the transfer nip portion 33 is greater than the predetermined value, the control unit 3 controls the driving source so that the outer downstream guide 72 is positioned at the second position after the downstream edge portion St of the sheet has passed an opposing position which the outer downstream guide 72 opposes and before the downstream edge portion St reaches the transfer nip portion 33.

Next, the operation of the image forming apparatus 1 described above will be described in detail. When type of sheet or thickness of sheet is entered through an operation unit or the like, the control unit 3 determines whether the sheet on which image is being formed is a thick paper having a basis weight greater than a predetermined value and executes a thick paper mode based on the determination. If basis weight of the sheet S2 conveyed through the registration roller pair 4 is greater than the predetermined value, the control unit 3 executes the thick paper mode. If basis weight of the sheet S1 conveyed through the registration roller pair 4 is equal to or smaller than the predetermined value, the control unit 3 positions the outer downstream guide 72 at the first position without executing the thick paper mode.

When the thick paper mode is executed, the image forming apparatus 1 operates as follows. At first, conveyance of the sheet S2 is started by driving the registration roller pair 4. The control unit 3 detects that the downstream edge portion St of the sheet S2 being conveyed has passed the sheet detection sensor 13. After elapse of a predetermined time after detection, the control unit 3 activates the drive motor 15 and moves the outer downstream guide 72 from the first position to the second position. Start time of the predetermined time is set to when the downstream edge portion St of the sheet S2 passes the sheet detection sensor 13. The predetermined time is a period of time that starts at the start time and ends when the drive motor 15 is activated to move the outer downstream guide 72 to the second position after the downstream edge portion St of the sheet S2 has abutted against the inner downstream guide 62 and before the downstream edge portion St reaches the transfer nip portion 33. The predetermined time is stored in the ROM 35 and set according to conveyance speed. That is, in the thick paper mode, before the sheet S2 conveyed by the registration roller pair 4 abuts against the inner downstream guide 62, the control unit 3 sets the outer downstream guide 72 to the first position. Further, in the thick paper mode, after the sheet S2 conveyed by the registration roller pair 4 abuts against the inner downstream guide 62 and before the sheet S2 reaches the transfer nip portion 33, the control unit 3 moves the outer downstream guide 72 from the first position to the second position. Thereby, speed reduction, i.e., impact, caused by the downstream edge portion St of the sheet S2 entering the transfer nip portion 33 is reduced and conveyance load is minimized. Thereby, when a high stiffness sheet such as thick paper is conveyed, suppression of impact caused at the intermediate transfer belt 44b or the transfer nip portion 33 and suppression of conveyance resistance can both be realized.

Further, after the sheet S2 passes the transfer nip portion 33 and before the conveyance of a subsequent sheet is started by the operation of the registration roller pair 4, the control unit 3 activates the drive motor 15 and moves the outer downstream guide 72 from the second position to the first position. If forming of image to sheets is performed continuously, the control unit 3 repeats the above-described sequence of operations.

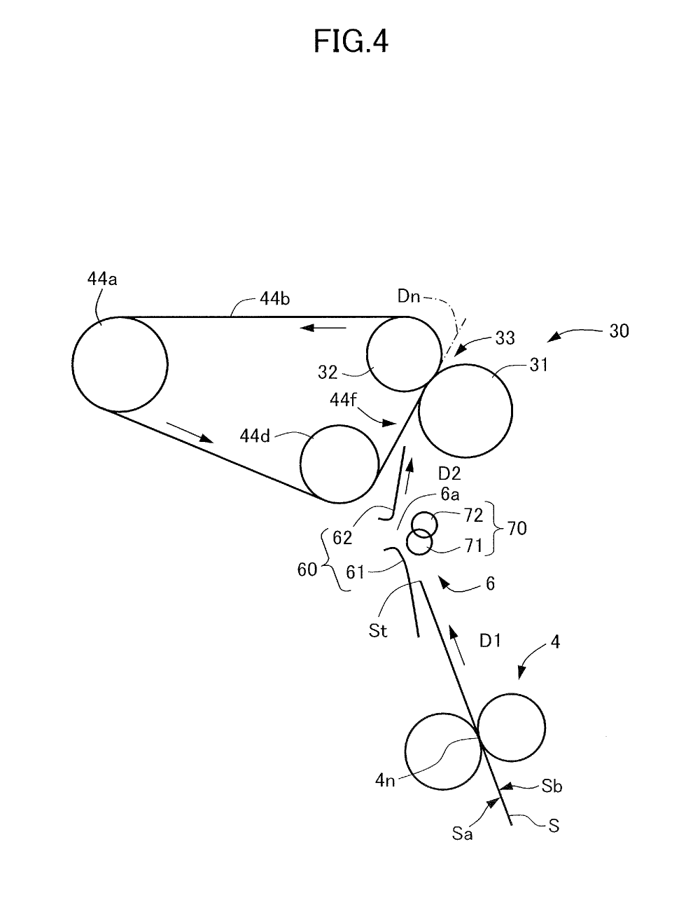

In order to verify the effect of the image forming apparatus 1 of the above-described embodiment, structure analysis simulation by finite element method was performed. As illustrated in FIG. 4, this simulation model is formed by modeling the image forming apparatus 1, and the reference numbers in the drawing correspond to the image forming apparatus 1 described above, so detailed descriptions of the components are omitted. In this simulation model, in order to cut down calculation time, the intermediate transfer belt 44b is shortened and image forming unit 40 is omitted. Further, the outer upstream guide 71 and the outer downstream guide 72 are illustrated as circular components, i.e., rollers, for simplification.

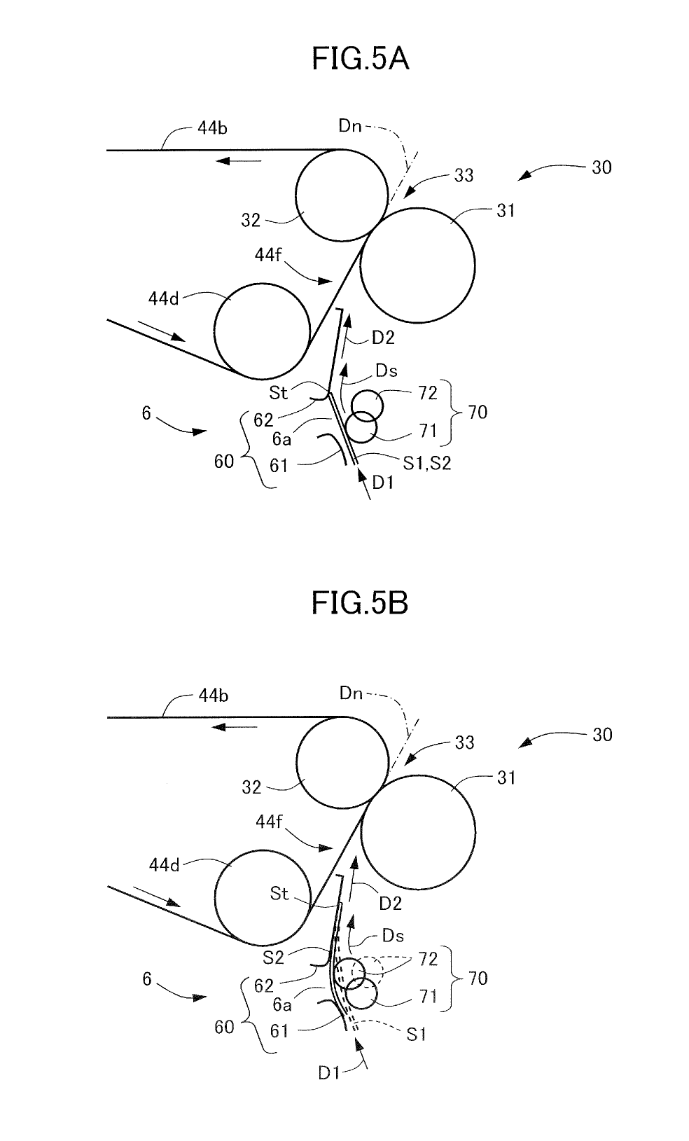

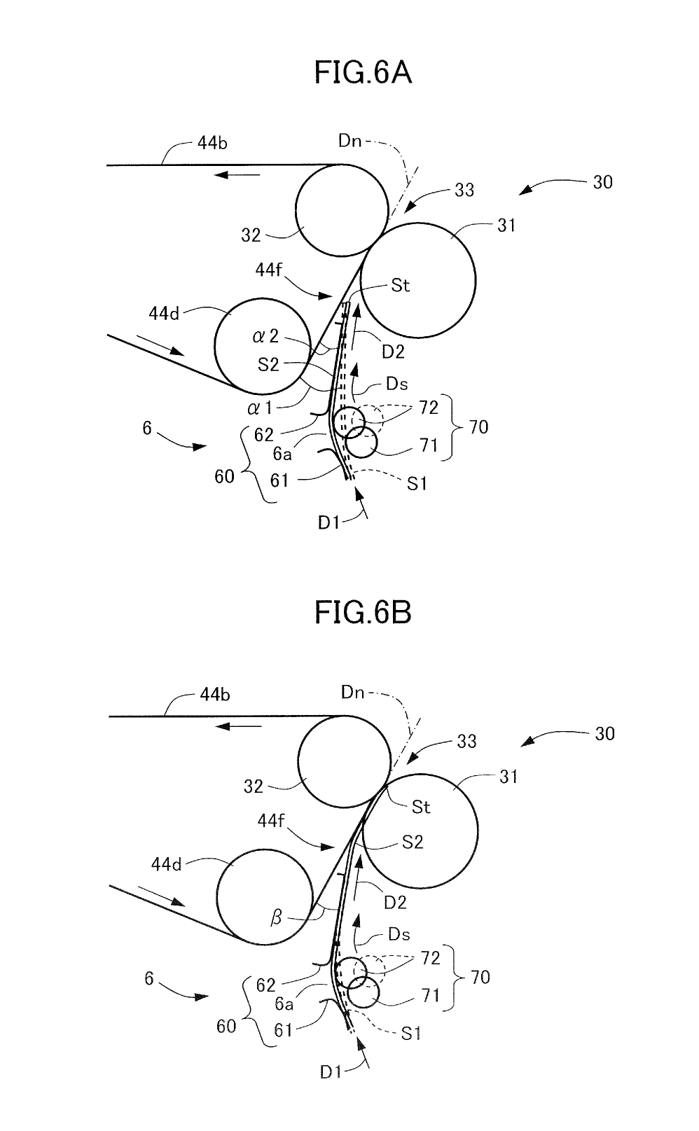

In FIGS. 5A through 6B, behavior of sheet S2 till the time when the downstream edge portion St at the sheet conveyance direction Ds passes through the transfer nip portion 33 via the sheet guide mechanism 6 is illustrated according to elapsed time. In order to compare the position of sheet S1 with the position of sheet S2 during execution of the thick paper mode, the position of the sheet S1 in the case where the outer downstream guide 72 is not moved to the second position is illustrated by dotted lines. At first, as illustrated in FIG. 5A, the downstream edge portion St of sheet S2 abuts against the inner downstream guide 62, and the sheet S2 is curved by being in contact with the outer upstream guide 71. As illustrated in FIG. 5B, by execution of the thick paper mode, the outer downstream guide 72 is moved to the second position after the downstream edge portion St of the sheet S2 passes the curved portion 6a. If the thick paper mode is not executed and the outer downstream guide 72 is retained at the first position, the sheet will be in the state of sheet S1, which has a shallower curve than the sheet S2.

Further, as illustrated in FIG. 6A, the downstream edge portion St of the sheet S2 abuts against the planar portion 44f of the intermediate transfer belt 44b before reaching the transfer nip portion 33. In this state, regarding the abutting angle to the planar portion 44f, angle α2 formed with the sheet S2 is smaller than angle α1 formed with the sheet S1. That is, even if the arrangement position of the inner upstream guide 61 is the same, the sheet S2 is conveyed further along the intermediate transfer belt 44b than the sheet S1. Then, as illustrated in FIG. 6B, in a state where the downstream edge portion St of sheet S2 had passed the transfer nip portion 33, the abutment angle with respect to the planar portion 44f is angle β for both sheet S1 and sheet S2.

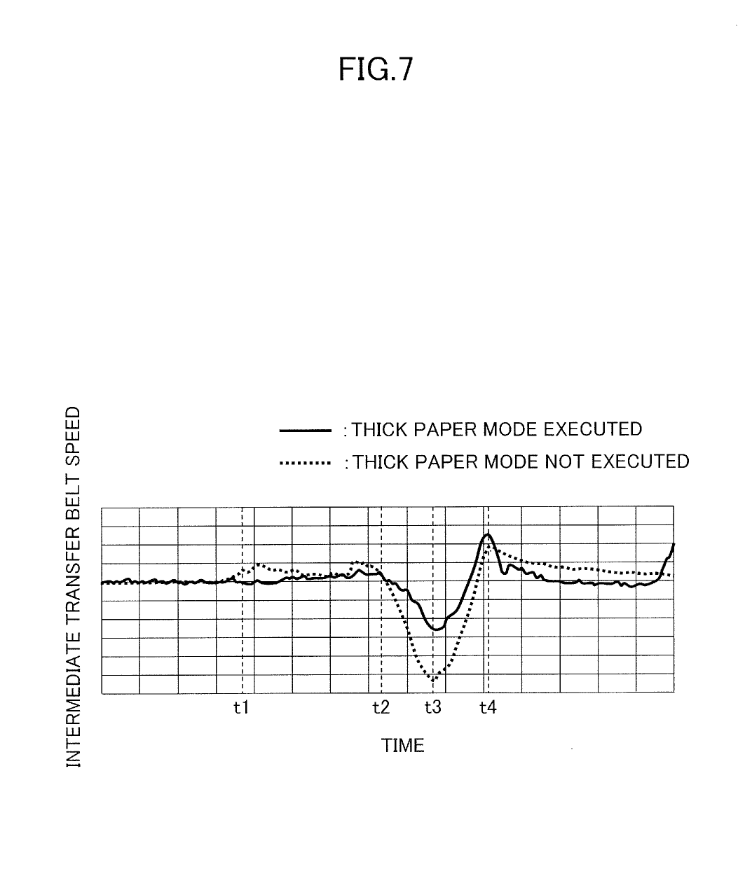

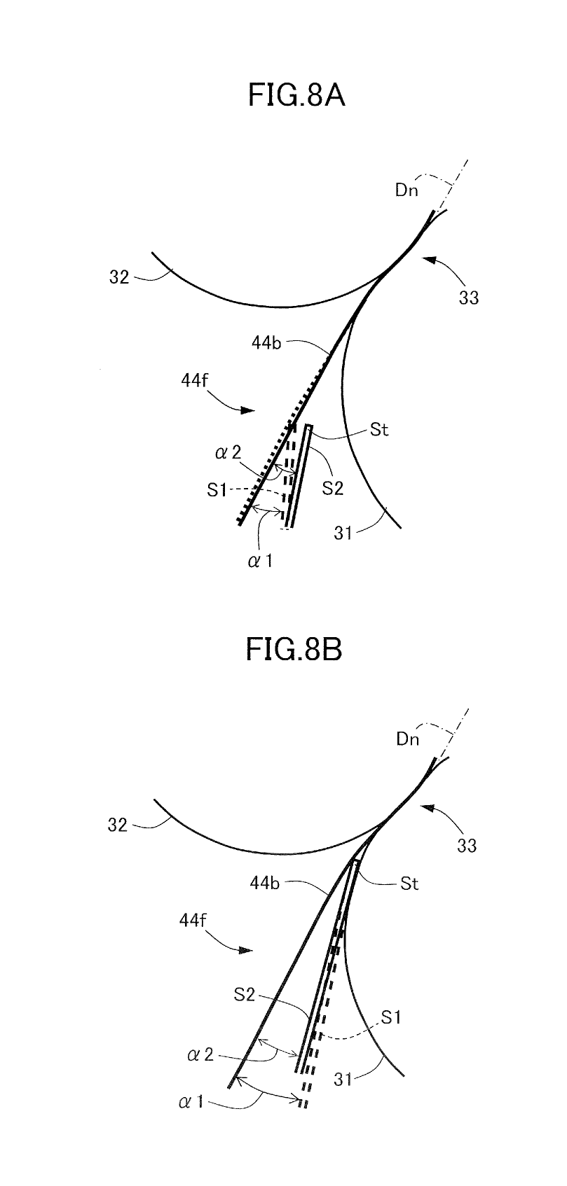

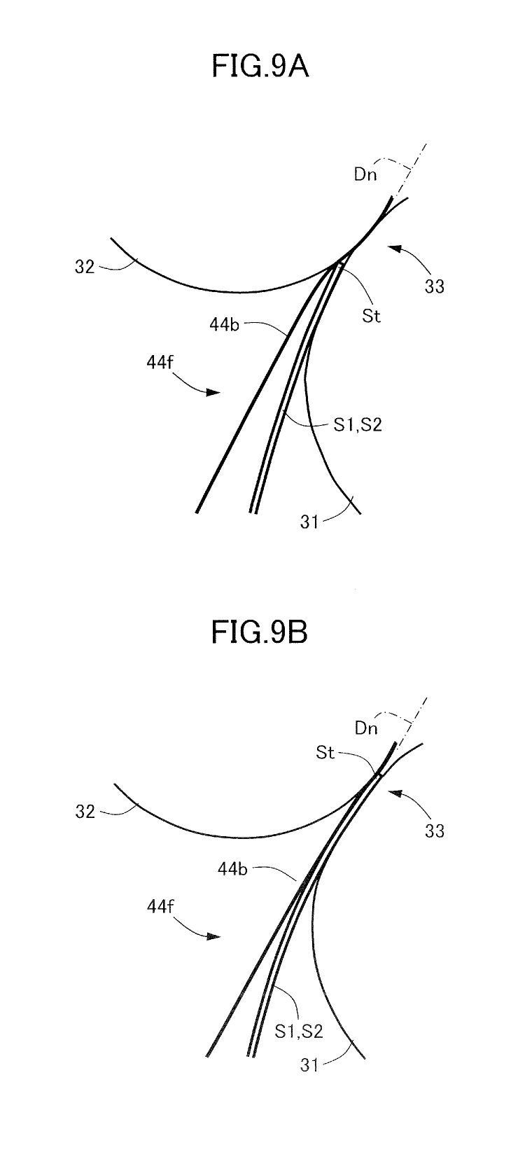

Next, speed fluctuation of the intermediate transfer belt 44b will be described. Speed fluctuation of the intermediate transfer belt 44b is acquired using the simulation model illustrated in FIG. 4. The result is illustrated in FIG. 7. Disorder of image increases as speed fluctuation of the intermediate transfer belt 44b increases, so that speed fluctuation should be as small as possible. Time t1 through t4 illustrated in FIG. 7 respectively correspond to the states of FIGS. 8A through 9B described later. As illustrated in FIG. 7, speed reduction has occurred when the downstream edge portion St of sheet S2 has entered the transfer nip portion 33 (t3). The speed reduction is smaller when the thick paper mode is executed and the outer downstream guide 72 is moved to the second position than when the thick paper mode is not executed and the outer downstream guide 72 is not moved to the second position.

It is assumed that speed reduction of the intermediate transfer belt 44b occurs by to the following process. At first, when the downstream edge portion St of the sheet enters the transfer nip portion 33, a task of deforming and moving the secondary transfer outer roller 31 according to the thickness of the sheet occurs. Further, there may be a case where the direction of entry of the sheet to the transfer nip portion 33 is angled with respect to a straight line direction, i.e., nip line direction Dn, which is a direction perpendicular to the straight line having connected the centers of the drive roller 44a and the secondary transfer outer roller 31. In this case, when the downstream edge portion St enters the transfer nip portion 33, a task of curving the sheet toward the nip line direction Dn occurs. According to these tasks, drive load of the intermediate transfer belt 44b occurs. According to the increase of load, speed reduction of driving source of the drive roller 44a that drives the intermediate transfer belt 44b occurs.

Meanwhile, according to the image forming apparatus 1 of the present embodiment, occurrence of drive load of the intermediate transfer belt 44b can be suppressed by executing the thick paper mode. The mechanism will be described in detail with reference to FIGS. 8A through 9B. Similar to FIGS. 5A through 6B, for comparison with the position of sheet S2 when the thick paper mode is executed, the position of the sheet S1 of the case where the thick paper mode is not executed and the outer downstream guide 72 is not moved to the second position is illustrated by dotted lines.

As illustrated in FIG. 8A, an abutment angle of the downstream edge portion St of the respective sheets S1 and S2 at time t1 (refer to FIG. 7) to the planar portion 44f of the intermediate transfer belt 44b is angle α1 when the thick paper mode is not executed and angle α2 that is smaller than angle α1 when the thick paper mode is executed. As illustrated in FIG. 8B, speed reduction of the intermediate transfer belt 44b starts at time t2 (refer to FIG. 7). In this state, the downstream edge portion St of the sheet S2 contacts both the intermediate transfer belt 44b and the secondary transfer outer roller 31, and deformation of elastic layer of the secondary transfer outer roller 31 is started. Even at this point of time, the abutment angle of the respective sheets S1 and S2 to the planar portion 44f is angle α1 when the thick paper mode is not executed and angle α2 that is smaller than angle α1 when the thick paper mode is executed.

As illustrated in FIG. 9A, time t3 (refer to FIG. 7) is the peak of speed reduction. In this state, the downstream edge portion St of the sheet S2 is sandwiched between the secondary transfer inner roller 32 and the secondary transfer outer roller 31 via the intermediate transfer belt 44b. At this point of time, the abutment angle of the respective sheets S1 and S2 to the planar portion 44f is equivalent in the cases where the thick paper mode is executed and where the thick paper mode is not executed. That is, the amount in which sheet S2 is curved is smaller than the amount in which sheet S1 is curved from the state of FIG. 8B to the state of FIG. 9A. Therefore, since the load is reduced accordingly, the speed reduction is considered to have been reduced. As illustrated in FIG. 9B, speed reduction is resolved at time t4 (refer to FIG. 7). Since the downstream edge portion St of the sheet S2 is nipped by the transfer nip portion 33, conveyance force of sheet S2 by the drive roller 44a is increased, and since task of the deformation and movement of the secondary transfer outer roller 31 is almost resolved, speed is considered to have been recovered to regular speed. The direction of the planar portion 44f of the intermediate transfer belt 44b with respect to the transfer nip portion 33 approximately matches the nip line direction Dn. That is, by executing the thick paper mode as according to the present embodiment, the angle α2 of the abutment angle is reduced and positioned along the planar portion 44f of the intermediate transfer belt 44b, so that speed reduction, i.e., impact, caused when the sheet S2 enters the transfer nip portion 33 is reduced.

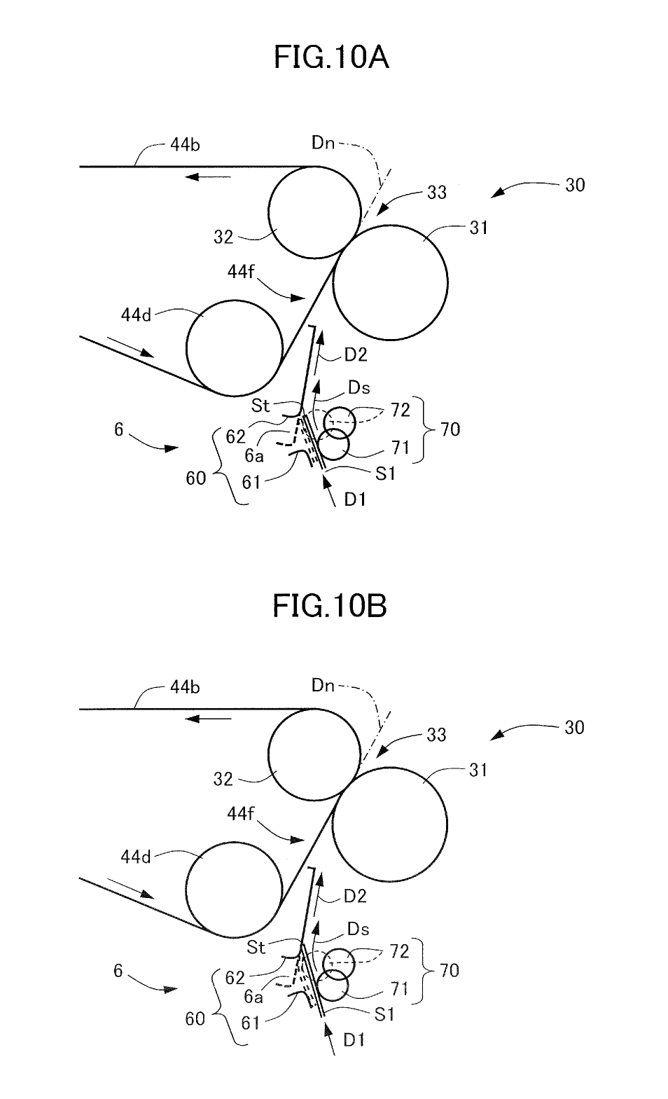

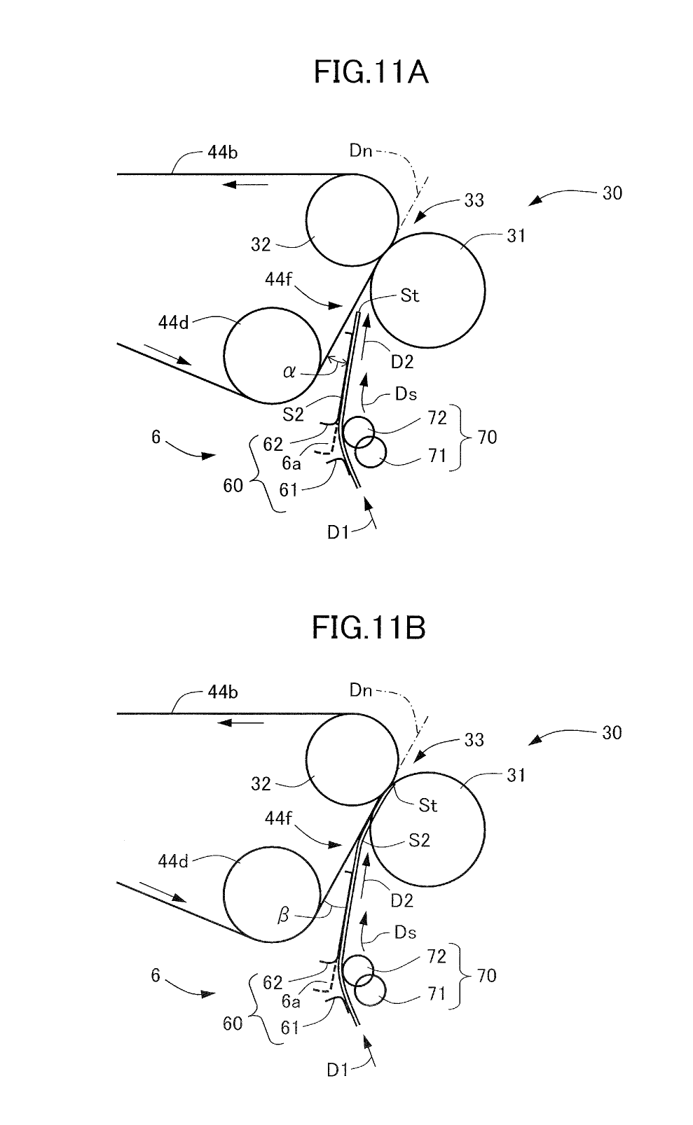

Next, the loads caused by conveyance of sheets S1 and S2 are compared between a case where the above-described thick paper mode is executed and the outer downstream guide 72 is moved and a case where the outer downstream guide 72 is fixed to the second position. FIGS. 10A through 11B respectively illustrate positions of sheets S1 and S2 at respective timings corresponding to FIGS. 5A through 6B. In FIGS. 10A and 10B, the position of the sheet S1 in a case where the outer downstream guide 72 is fixed to the second position is illustrated by the dotted lines. At first, as illustrated in FIG. 10A, the downstream edge portion St of sheet S1 or S2 is abutted against the inner downstream guide 62, and the sheet S1 or S2 is curved by being in contact with the outer downstream guide 72. Then, as illustrated in FIG. 10B, the curve when the downstream edge portion St passes the curved portion 6a is greater for sheet S1 in the state where the outer downstream guide 72 is fixed to the second position illustrated by the dotted line compared to the sheet S2 in the state where the thick paper mode is executed. Thereafter, as illustrated in FIG. 11A, even in the thick paper mode, the outer downstream guide 72 moves to the second position, so that in both cases where the thick paper mode is executed and where the outer downstream guide 72 is fixed to the second position, the abutment angles a against the planar portion 44f of the intermediate transfer belt 44b are the same. Then, as illustrated in FIG. 11B, in a state where the downstream edge portion St of sheet S2 passes the transfer nip portion 33, the abutment angle against the planar portion 44f is angle β, equivalent for both sheet S1 and sheet S2.

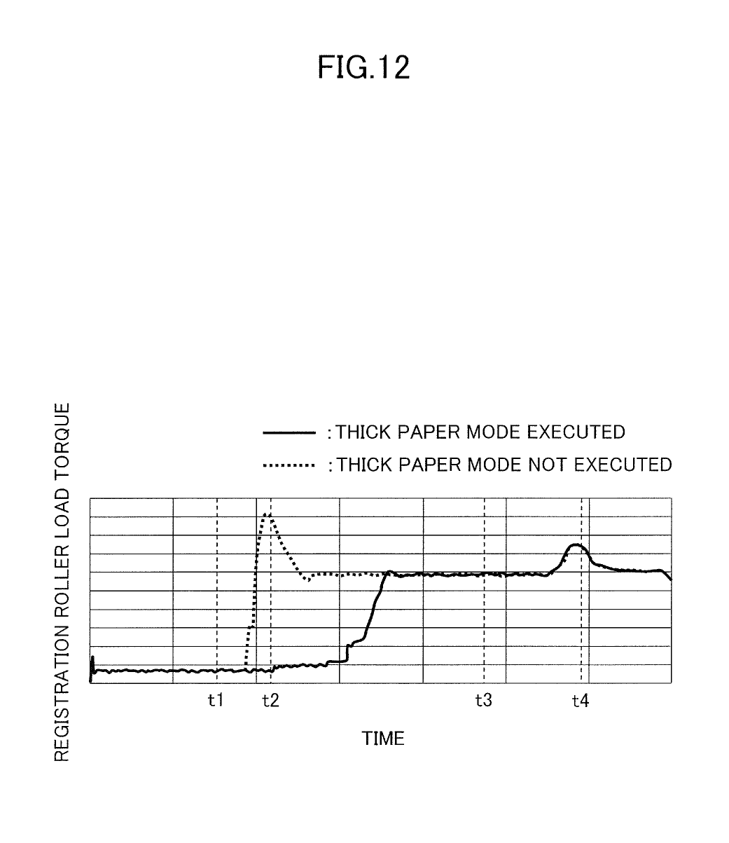

FIG. 12 illustrates a comparison result of loads caused by conveyance of sheet S1 and sheet S2 of a case where the above-described thick paper mode is executed and the outer downstream guide 72 has been moved and a case where the outer downstream guide is fixed to the second position. Time t1 through t4 illustrated in FIG. 12 respectively correspond to the states of FIGS. 10A through 11B. As illustrated in FIG. 10B, if the outer downstream guide 72 is fixed to the second position, rapid increase of torque at time t2 occurs by the sheet S1 being curved. Meanwhile, in the thick paper mode, the outer downstream guide 72 is at the first position at time t2, so that such increase of torque does not occur. In the thick paper mode, the outer downstream guide 72 moves to the second position from FIG. 10B to FIG. 11A. Torque is increased accordingly, but the level of increase is gentle, and the peak is small. As illustrated in FIG. 11B, increase of torque occurs at time t4 when the sheet S1 or S2 enters the transfer nip portion 33, but the peak is the same for both cases and is smaller than the peak at time t2 of the case where the outer downstream guide 72 is fixed to the second position. Therefore, it can be recognized that the conveyance load is reduced by executing the thick paper mode, since the curve of the sheet is shallower if the outer downstream guide 72 is positioned at the first position while the downstream edge portion St passes the curved portion 6a.

As described, according to the image forming apparatus 1 of the present embodiment, the control unit 3 executes the thick paper mode if the basis weight of the sheet S conveyed by the registration roller pair 4 is greater than a predetermined value. In the thick paper mode, the control unit 3 sets the position of the outer downstream guide 72 to the first position before the sheet S2 conveyed by the registration roller pair 4 abuts against the inner downstream guide 62. That is, the control unit 3 sets the outer downstream guide 72 to the first position before the sheet conveyed by the registration roller pair 4 passes the curved portion 6a, or the outer downstream guide 72, of the conveyance path. Further, the control unit 3 moves the outer downstream guide 72 from the first position to the second position after the conveyed sheet S2 abuts against the inner downstream guide 62 and before the sheet S2 reaches the transfer nip portion 33. In other words, in the thick paper mode, the control unit 3 moves the outer downstream guide 72 from the first position to the second position while the sheet conveyed by the registration roller pair 4 passes the curved portion 6a, or outer downstream guide 72, of the conveyance path and before the sheet reaches the transfer nip portion 33. Thereby, the speed reduction, i.e., impact, caused when the downstream edge portion St of the sheet S2 enters the transfer nip portion 33 can be reduced, and conveyance load can be minimized. Therefore, occurrence of impact and conveyance resistance of the intermediate transfer belt 44b and the transfer nip portion 33 can both be suppressed when conveying high stiffness sheets S2 such as thick paper.

According further to the image forming apparatus 1 of the present embodiment, if the basis weight of the sheet S1 conveyed by the registration roller pair 4 is equal to or smaller than the predetermined value, the control unit 3 sets the position of the outer downstream guide 72 to the first position without executing the thick paper mode. Thereby, in a state where the sheet being conveyed is the sheet S1 having low stiffness, the present embodiment enables to suppress occurrence of sheet jam caused by the outer downstream guide 72 moving to the second position and increasing the curve of the conveyance path. In the sheet S1 having low stiffness, even if the sheet S1 abuts against the intermediate transfer belt 44b at a sharp angle with the outer downstream guide 72 set at the first position, the impact that occurs when the sheet abuts against the intermediate transfer belt 44b is small, such that fluctuation of speed of the intermediate transfer belt 44b rarely occurs.

The image forming apparatus 1 according to the above-described embodiment was described based on a case where the pressing member is the outer downstream guide 72 which is approximately plate shaped and a position of the whole body is displaced to the first position and the second position, but the present invention is not restricted to this example. For example, the pressing member may also be a roller that is displaced to the first position and the second position, as illustrated in FIG. 4.

Further, the image forming apparatus 1 of the above-described embodiment was described based on a case where the outer downstream guide 72 is switched between the first position and the second position during conveyance of thick paper, but the present invention is not restricted thereto. For example, in a case where a thick paper having a basis weight that is greater than the predetermined value is conveyed, the outer downstream guide 72 can be constantly fixed to the second position. Meanwhile, if the basis weight of the sheet is equal to or smaller than the predetermined value, the outer downstream guide 72 can be positioned at the first position. That is, a configuration can be adopted where the position of the outer downstream guide 72 is switched according to the basis weight of the sheet.

### Second Embodiment

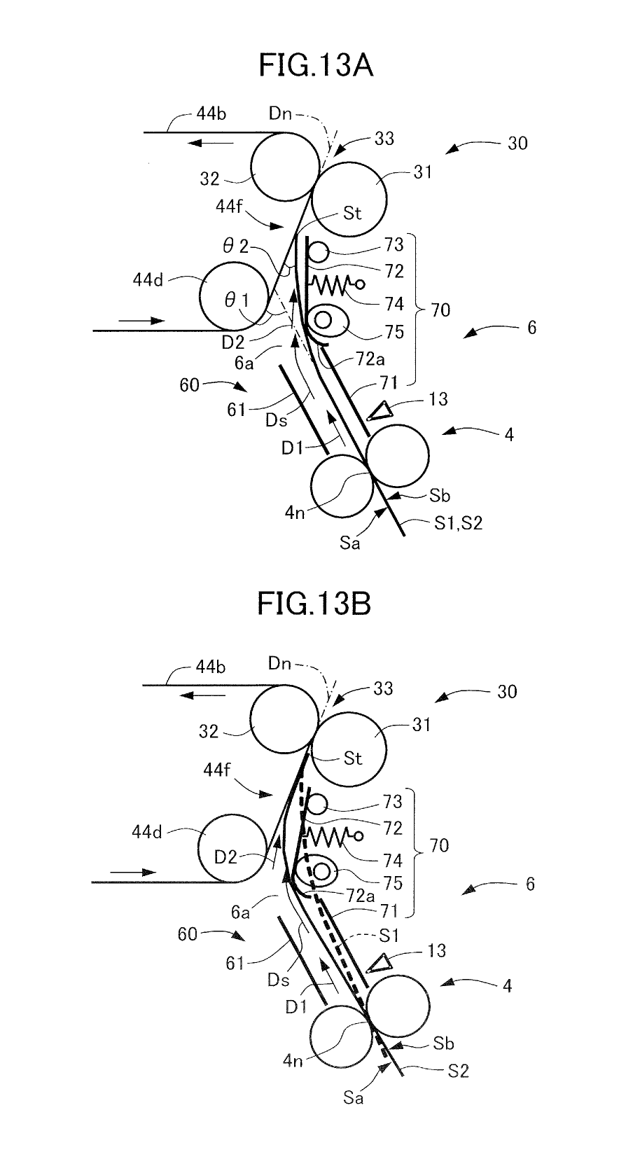

Next, a second embodiment of the present invention will be described in detail with reference to FIGS. 13A through 19. The configuration of the present embodiment differs from that of the first embodiment in that the inner downstream guide 62 is not provided. The other configurations are the same as the first embodiment, so that the same reference numbers are assigned to the same components and detailed descriptions thereof are omitted.

In the present embodiment, the sheet guide mechanism 6 includes an inner guide portion 60 and an outer guide portion 70, a part of which are mutually opposed to one another. The inner guide portion 60 includes an inner upstream guide 61 that is arranged at a position opposed to an outer upstream guide 71 of the outer guide portion 70. A secondary transfer inner roller 32 corresponds to a first stretch roller that stretches the intermediate transfer belt 44b. Further, a driven roller 44d corresponds to a second stretch roller that stretches the intermediate transfer belt 44b at a position adjacent to the secondary transfer inner roller 32 on an upstream side in the rotation direction of the intermediate transfer belt 44b. The portion of the intermediate transfer belt 44b stretched between the secondary transfer inner roller 32 and the driven roller 44d is formed as a planar portion, i.e., stretched portion, 44f.

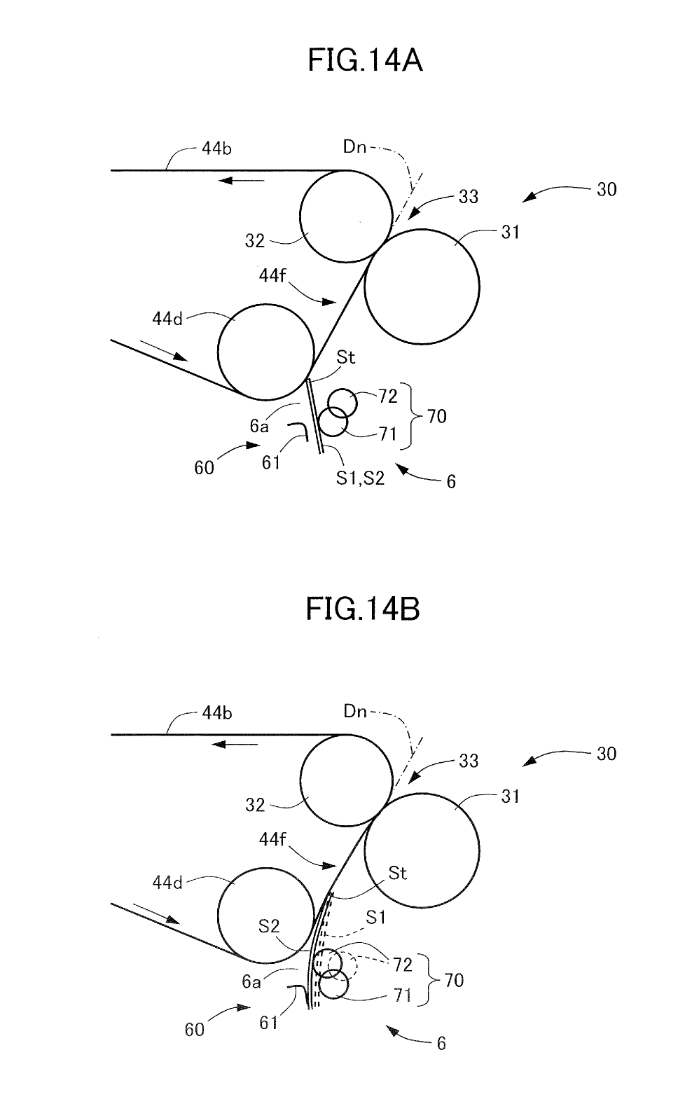

The secondary transfer outer roller, i.e., rotary member, 31 is disposed on the outer circumferential side of the intermediate transfer belt 44b and nips the intermediate transfer belt 44b with the secondary transfer inner roller 32. Further, the secondary transfer outer roller 31 forms a transfer nip portion 33 where toner image is transferred from the intermediate transfer belt 44b to the sheet while conveying the sheet between the intermediate transfer belt 44b. Further, a registration roller pair, i.e., conveyance roller, 4 conveys the sheet toward the planar portion 44f of the intermediate transfer belt 44b upstream of the transfer nip portion 33 in the sheet conveyance direction Ds. In the present embodiment, the registration roller pair 4 conveys the sheet toward a driven roller 44d that stretches the planar portion 44f (refer to FIG. 14A). After the conveyed sheet abuts against the planar portion 44f, the registration roller pair 4 conveys the sheet along the planar portion 44f toward the transfer nip portion 33.

An outer downstream guide, i.e., pressing portion, 72 is arranged to face at least a part of the planar portion 44f, and formed movably between a first position and a second position that is closer to the planar portion 44f than the first position. That is, the outer downstream guide 72 adopts a configuration capable of changing positions by rotation of an eccentric cam 75 between the first position where the curved portion 6a has a shallow curve, as illustrated in FIG. 13A, and the second position where the curved portion 6a has a deeper curve, as illustrated in FIG. 13B. Further, the outer downstream guide 72 is disposed upstream of the transfer nip portion 33 in the sheet conveyance direction Ds and downstream of the conveyance nip portion 4n in the sheet conveyance direction Ds, forming a conveyance path with the planar portion 44f through which sheets are conveyed. The outer downstream guide 72 is movable between the first position and the second position, the second position entering the conveyance path formed by the outer downstream guide 72 positioned at the first position and where outer downstream guide 72 presses a surface Sb of the sheet opposite to the transfer surface Sa on which toner is transferred.

In the thick paper mode, the control unit 3 sets the position of the outer downstream guide 72 to the first position before the sheet conveyed by the registration roller pair 4 abuts against the planar portion 44f. That is, the control unit 3 sets the position of the outer downstream guide 72 to the first position before the sheet conveyed by the registration roller pair 4 passes the curved portion 6a, or outer downstream guide 72, of the conveyance path. Further, the control unit 3 moves the outer downstream guide 72 from the first position to the second position after the sheet conveyed by the registration roller pair 4 abuts against the planar portion 44f and before it reaches the transfer nip portion 33. In other words, in the thick paper mode, the control unit 3 moves the outer downstream guide 72 from the first position to the second position while the sheet conveyed by the registration roller pair 4 passes the curved portion 6a, or outer downstream guide 72, of the conveyance path and before the sheet reaches the transfer nip portion 33.

As illustrated in FIG. 13A, the curved portion 6a has a shallow curve when the outer downstream guide 72 is positioned at the first position, and as illustrated in FIG. 13B, the curved portion 6a has a deeper curve when the outer downstream guide 72 is positioned at the second position. In FIG. 13B, the shape of the sheet S1 having a shallow curve according to FIG. 13A is illustrated by broken lines.

During execution of the thick paper mode, as illustrated in FIG. 13A, the sheet S2 is conveyed by the registration roller pair 4, the downstream edge portion St of the sheet S2 abuts against the planar portion 44f, and thereafter the sheet S2 is guided along the planar portion 44f and a portion of the sheet S2 contacts the pressure edge portion 72a. As described, in a state where the outer downstream guide 72 is positioned at the first position, the sheet S2 is conveyed without being curved greatly. The sheet S2 is retained by the registration roller pair 4 and the planar portion 44f, and curves by being in contact with the pressure edge portion 72a between the registration roller pair 4 and the planar portion 44f.

After elapse of a predetermined time after the sheet detection sensor 13 has detected the downstream edge portion St of the sheet S2, as illustrated in FIG. 13B, the outer downstream guide 72 moves to the second position. The sheet S2 is pressed toward the planar portion 44f by the pressure edge portion 72a and is greatly curved along the pressure edge portion 72a. Therefore, in a state where the outer downstream guide 72 is at the second position, compared to the first position, the downstream edge portion St of the sheet S2 enters the transfer nip portion 33 in a state where the sheet S2 is positioned along the planar portion 44f of the intermediate transfer belt 44b. That is, the sheet being conveyed from the registration roller pair 4 abuts against the intermediate transfer belt 44b without having the transfer surface Sa of the sheet guided by a guide member. That is, no guide member is provided between the intermediate transfer belt 44b and the outer downstream guide 72.

As for the operation of the image forming apparatus 1 of the present embodiment, similar to the first embodiment, the control unit 3 executes the thick paper mode if the basis weight of the sheet S2 conveyed by the registration roller pair 4 is greater than a predetermined value. Further, if the basis weight of the sheet S2 conveyed by the registration roller pair 4 is equal to or smaller than the predetermined value, the control unit 3 sets the position of the outer downstream guide 72 to the first position without executing the thick paper mode.

In the thick paper mode, the control unit 3 sets the outer downstream guide 72 to the first position before the sheet S2 conveyed by the registration roller pair 4 abuts against the planar portion 44f. Further, in the thick paper mode, the control unit 3 moves the outer downstream guide 72 from the first position to the second position after the sheet S2 conveyed by the registration roller pair 4 abuts against the planar portion 44f and before the sheet reaches the transfer nip portion 33. Further, the control unit 3 activates the drive motor 15 and moves the outer downstream guide 72 from the second position to the first position after the sheet S2 has passed the transfer nip portion 33 and before a subsequent sheet S2 is started to be conveyed by driving the registration roller pair 4. In forming images continuously to sheets S2, the control unit 3 repeatedly performs the above-described set of operations. Thereby, the speed reduction, i.e., impact, caused when the downstream edge portion St of the sheet S2 enters the transfer nip portion 33 can be reduced, and conveyance load can be minimized. Therefore, occurrence of impact and conveyance resistance of the intermediate transfer belt 44b and the transfer nip portion 33 can both be suppressed while conveying the high stiffness sheet S2 such as thick paper.

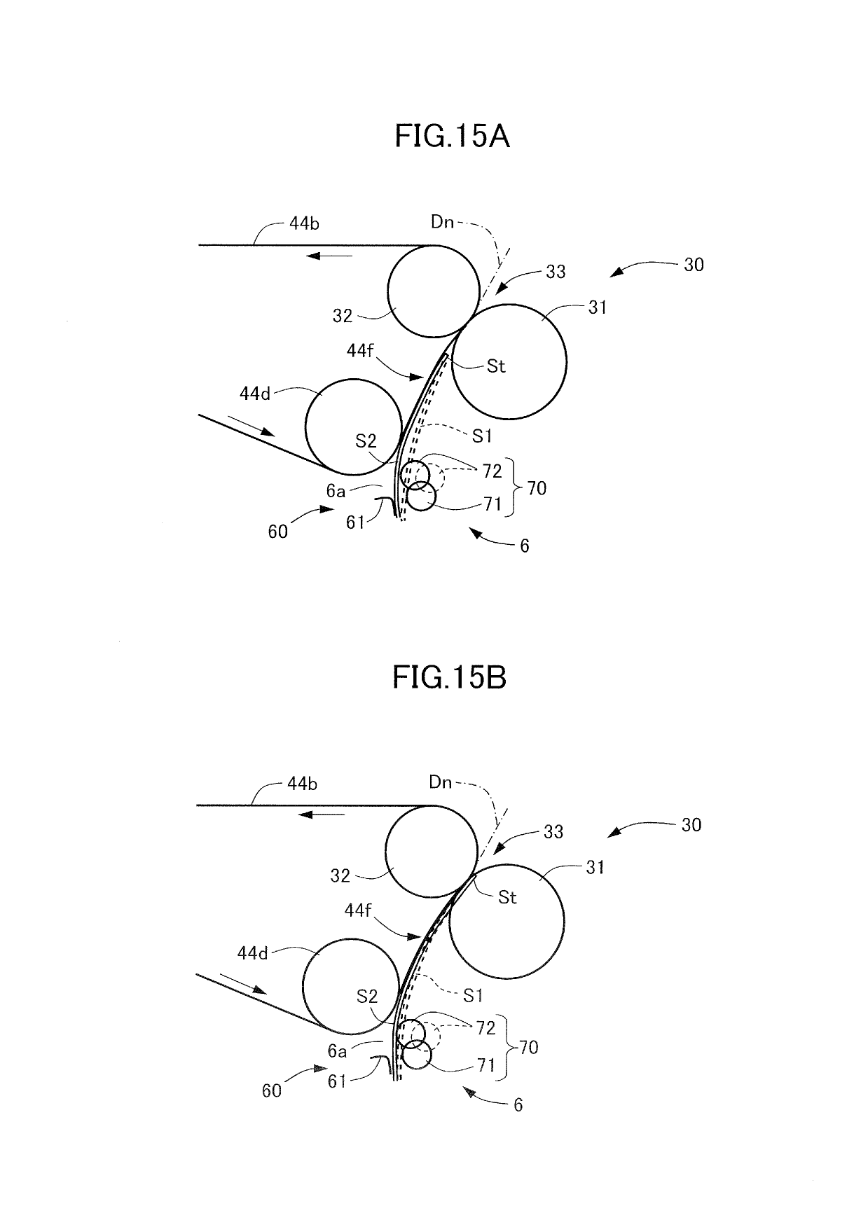

Now, in order to verify the effect of the image forming apparatus 1 of the above-described embodiment, structure analysis simulation by finite element method is performed, similar to the first embodiment. In FIGS. 14A through 15B, behavior of sheet S2 from when the downstream edge portion St at the sheet conveyance direction Ds (refer to FIG. 13A) passes through the transfer nip portion 33 via the sheet guide mechanism 6 is illustrated according to elapsed time. In order to compare the position of sheet S1 with the position of sheet S2 during execution of the thick paper mode, the position of the sheet S1 in the case where the outer downstream guide 72 is not moved to the second position is illustrated by dotted lines. At first, as illustrated in FIG. 14A, the downstream edge portion St of the sheet S2 abuts against the planar portion 44f, and the sheet S2 is curved by being in contact with the outer upstream guide 71. As illustrated in FIG. 14B, by execution of the thick paper mode, the outer downstream guide 72 is moved to the second position after the downstream edge portion St of the sheet S2 passes the curved portion 6a. If the thick paper mode is not executed and the outer downstream guide 72 is retained at the first position, the sheet will be in the state of sheet S1, which has a shallower curve than the sheet S2.

Further, as illustrated in FIG. 15A, the downstream edge portion St of the sheet S2 is positioned sufficiently along the planar portion 44f before reaching the transfer nip portion 33, and the abutment angle to the planar portion 44f is approximately 0 degrees with respect to the angle formed with the sheet S1. That is, even if the position of the inner upstream guide 61 is the same, the sheet S2 is conveyed further along the intermediate transfer belt 44b than sheet S1. Then, as illustrated in FIG. 15B, when the downstream edge portion St of the sheet S2 passes the transfer nip portion 33, the abutment angle with respect to the planar portion 44f is approximately 0 degrees for both sheet S1 and sheet S2.

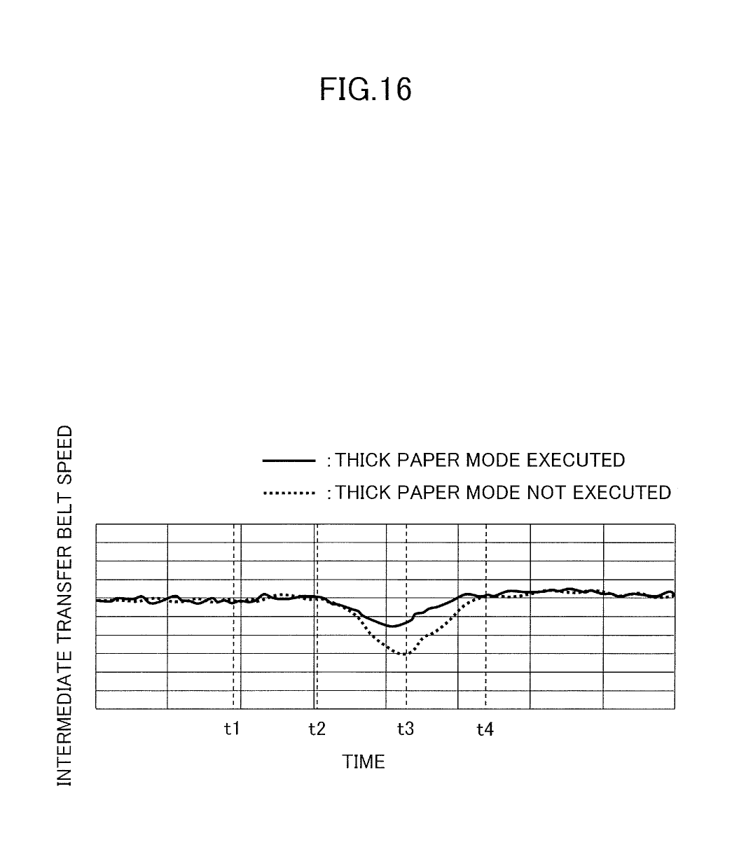

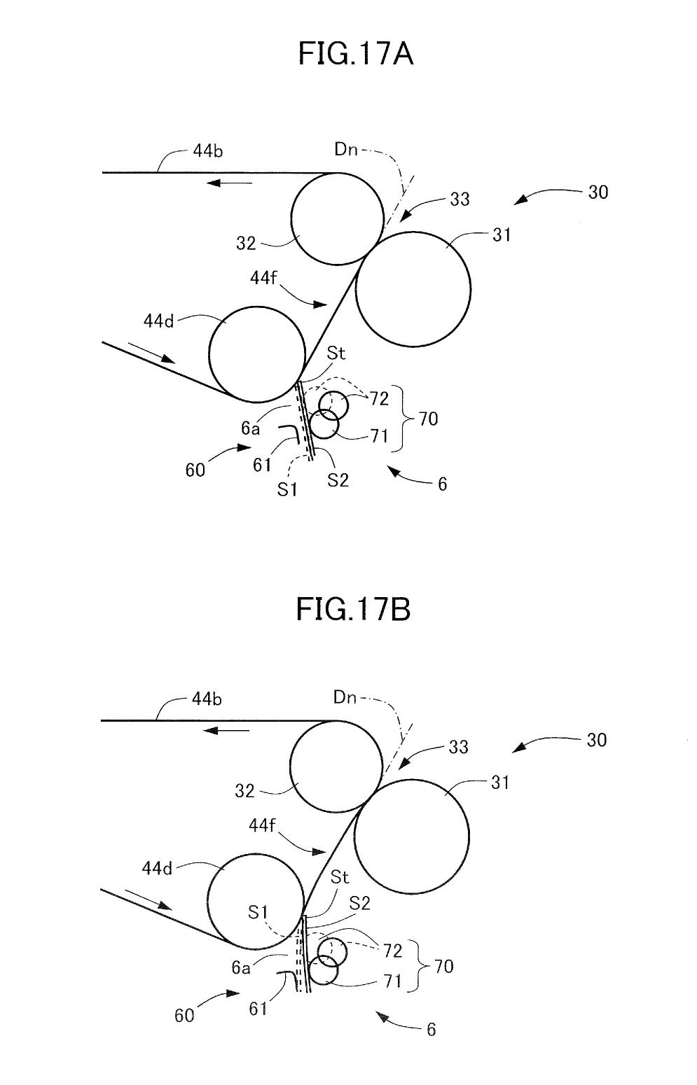

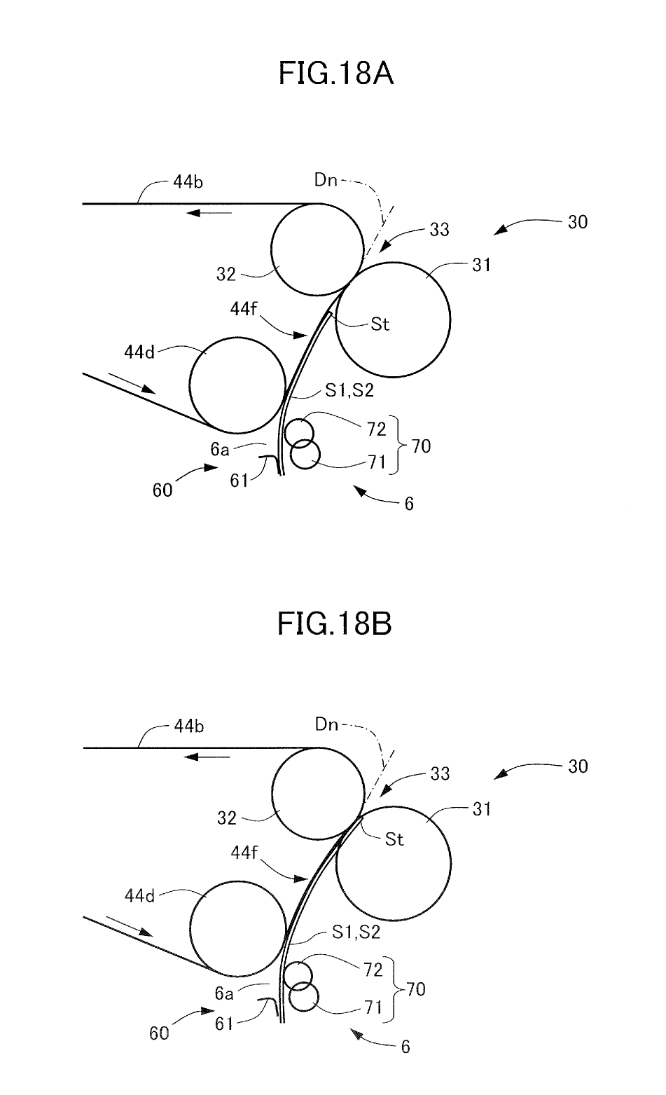

Next, speed fluctuation of the intermediate transfer belt 44b will be described. Speed fluctuation of the intermediate transfer belt 44b is acquired using the simulation model illustrated in FIGS. 14A through 15B. The result is illustrated in FIG. 16. Time t1 through t4 illustrated in FIG. 16 respectively correspond to the states of FIGS. 17A through 18B described later. As illustrated in FIG. 16, speed reduction is smaller when the thick paper mode is executed compared to when the thick paper mode is not executed. This is because when the thick paper mode is executed, the amount of curve of the sheet S2 from the state shown in FIG. 15A to the state shown in FIG. 15B is smaller compared to when the thick paper mode is not executed. That is, it can be recognized that the speed reduction is smaller when the thick paper mode is executed and the outer downstream guide 72 is moved to the second position compared to when the thick paper mode is not executed and the outer downstream guide 72 is not moved to the second position.

Next, the loads caused by conveyance of sheets S1 and S2 are compared between a case where the above-described thick paper mode is executed and where the thick paper mode is not executed. FIGS. 17A through 18B respectively illustrate positions of sheets S1 and S2 at respective timings corresponding to FIGS. 14A through 15B. In FIGS. 17A and 17B, the position of the sheet S1 in a case where the outer downstream guide 72 is fixed to the second position is illustrated by dotted line. At first, as illustrated in FIG. 17A, the downstream edge portion St of sheet S1 or S2 is abutted against the planar portion 44f, and the sheet S1 or S2 is curved by being in contact with the outer downstream guide 72. Then, as illustrated in FIG. 17B, the curve when the downstream edge portion St passes the curved portion 6a is greater for sheet S1 in the state where the outer downstream guide 72 is fixed to the second position illustrated by the dotted line compared to the sheet S2 in the state where the thick paper mode is executed. Thereafter, as illustrated in FIG. 18A, even in the thick paper mode, the outer downstream guide 72 moves to the second position, so that in both cases where the thick paper mode is executed and where the thick paper mode is not executed, the abutment angle against the planar portion 44f of the intermediate transfer belt 44b is approximately zero. Then, as illustrated in FIG. 18B, in a state where the downstream edge portion St of sheet S2 passes the transfer nip portion 33, the abutment angle against the planar portion 44f is approximately zero, equivalent for both sheet S1 and sheet S2.

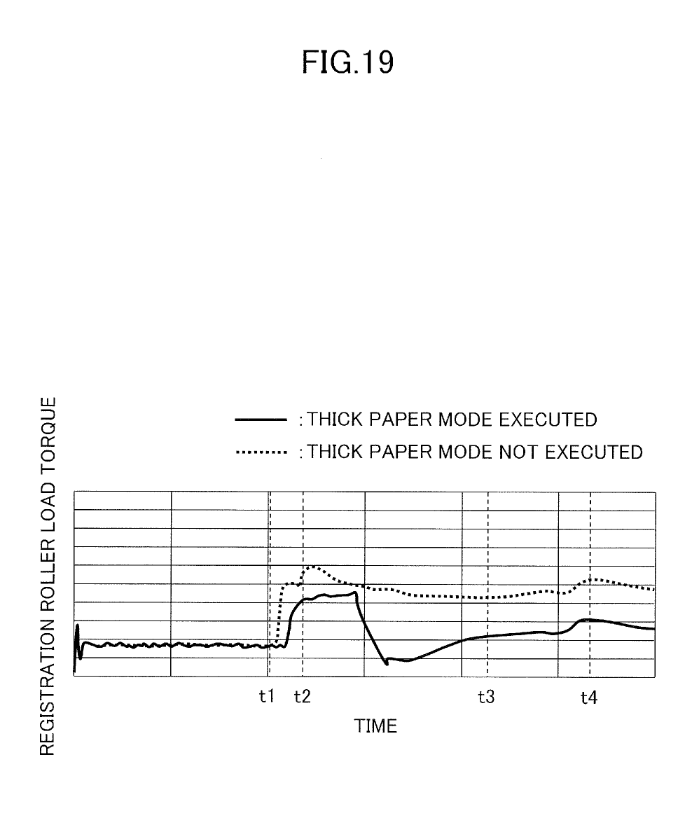

FIG. 19 illustrates a comparison result of loads caused by conveyance of sheet S1 and sheet S2 of a case where the above-described thick paper mode is executed and a case where the thick paper mode is not executed. Times t1 through t4 illustrated in FIG. 19 respectively correspond to the states of FIGS. 17A through 18B. As illustrated in FIG. 17B, if the outer downstream guide 72 is fixed to the second position, rapid increase of torque at time t2 occurs by the sheet S1 being curved. Meanwhile, in the thick paper mode, the outer downstream guide 72 is at the first position at time t2, so that such increase of torque does not occur. In the thick paper mode, the outer downstream guide 72 moves to the second position between FIG. 17B and FIG. 18A. Torque is increased accordingly, since the outer downstream guide 72 enters the side surface of the sheet S2, by which the sheet S2 is buckled and curved. Thereby, the torque drops. As illustrated in FIG. 18B, increase of torque occurs at time t4 when the sheet S1 or S2 enters the transfer nip portion 33, but the peak is smaller than time t2 where the outer downstream guide 72 is fixed to the second position. Therefore, it can be recognized that the conveyance load is reduced by executing the thick paper mode, since the curve of the sheet S2 is shallower if the outer downstream guide 72 is positioned at the first position while the downstream edge portion St passes the curved portion 6a.

Also according to the image forming apparatus 1 of the present embodiment, in the thick paper mode, the control unit 3 sets the position of the outer downstream guide 72 to the first position before the sheet S2 conveyed by the registration roller pair 4 abuts against the planar portion 44f Further, the control unit 3 moves the outer downstream guide 72 from the first position to the second position after the conveyed sheet S2 abuts against the planar portion 44f and before it reaches the transfer nip portion 33. Thereby, the speed reduction, i.e., impact, caused when the downstream edge portion St of the sheet S2 enters the transfer nip portion 33 can be reduced, and conveyance load can be minimized. Therefore, occurrence of impact and conveyance resistance of the intermediate transfer belt 44b and the transfer nip portion 33 can both be suppressed when conveying high stiffness sheets S2 such as thick paper.

According to the image forming apparatus 1 of the present embodiment, the sheet S2 contacts the planar portion 44f before entering the transfer nip portion 33, so that the sheet S2 is arranged further along the intermediate transfer belt 44b and the downstream edge portion St of the sheet enters the nip in a direction close to the nip line direction Dn. Therefore, the present embodiment exerts an effect of further minimizing the speed reduction, i.e., impact, during entry.

Further according to the image forming apparatus 1 of the present embodiment, the registration roller pair 4 conveys the sheet S2 toward the driven roller 44d that stretches the planar portion 44f. Therefore, deflection of the belt that occurs when the sheet S2 abuts against the planar portion 44f can be suppressed, and therefore, speed fluctuation of the intermediate transfer belt 44b can be suppressed. Since the position in which the sheet S2 abuts against the planar portion 44f is separated from the transfer nip portion 33, there is a distance from where the sheet abuts against the planar portion 44f to where the sheet is nipped by the transfer nip portion 33, and the curvature of the sheet S2 is gentle. Therefore, the resistance received from the sheet S2 when nipping the sheet S2 by the transfer nip portion 33 can be reduced, and speed reduction of the intermediate transfer belt 44b can be suppressed.

### Third Embodiment

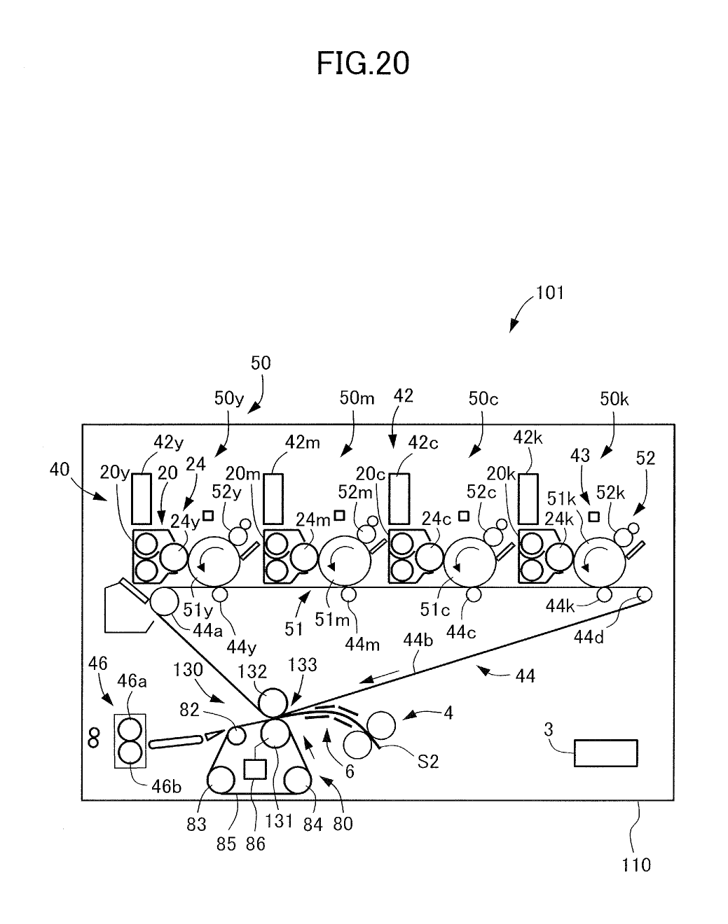

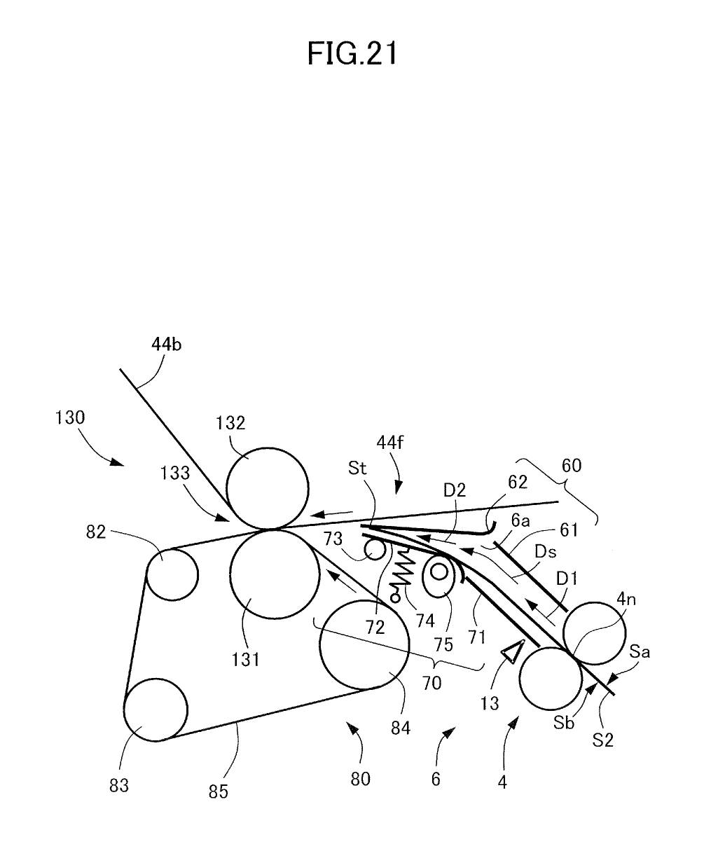

Next, a third embodiment of the present invention will be described in detail with reference to FIGS. 20 and 21. A configuration of an image forming apparatus 101 according to the present embodiment differs from the configuration of the first embodiment that adopts a vertical path system in that a horizontal path system where the sheet S2 is conveyed approximately horizontally is adopted in a secondary transfer portion 130. Therefore, according to the present embodiment, a drum cartridge 50, a developing apparatus 20 and a laser scanner 43 are arranged above an intermediate transfer belt, serving as a belt member or a first belt member, 44b, and the secondary transfer portion 130 is arranged below the intermediate transfer belt 44b. Further according to the present embodiment, a secondary transfer inner roller 132 is disposed below a driven roller 44d. Moreover, the driven roller 44d is arranged at a position projected larger than the secondary transfer inner roller 132 with respect to a direction in which the driven roller 44d presses the intermediate transfer belt 44b horizontally. The other configurations are the same as the first embodiment, so that the same reference numbers are assigned to the same components and detailed descriptions thereof are omitted.

The secondary transfer portion 130 includes the secondary transfer inner roller, i.e., first stretch roller, 132 and a secondary transfer belt unit 80. The secondary transfer inner roller 132 abuts against an inner side surface of the intermediate transfer belt 44b. The secondary transfer belt unit 80 includes a secondary transfer outer roller, serving as roller, 131, a conveyance surface formation roller 82, a tension roller 83, a driving roller 84, and a secondary transfer belt, serving as rotary member or second belt member, 85 that is wound around these rollers and rotated. The secondary transfer belt 85 is driven by the driving roller 84 and rotates in the direction of the arrow. A transfer nip portion 133 is formed at an area where the intermediate transfer belt 44b and the secondary transfer belt 85 are pressed by the secondary transfer inner roller 132 and the secondary transfer outer roller 131. That is, the secondary transfer inner roller 132 nips the intermediate transfer belt 44b and the secondary transfer belt 85 with the secondary transfer outer roller 131. The secondary transfer belt unit 80 causes the secondary transfer belt 85 to bear a sheet S2 and pass through the transfer nip portion 133. The use of the secondary transfer belt 85 enables the sheet S2 to be separated easily from the intermediate transfer belt 44b after transfer of toner image at the transfer nip portion 133, and the sheet S2 can be conveyed stably to the fixing unit 46.

A secondary transfer power supply 86 having a variable output current is connected to the secondary transfer outer roller 131 (refer to FIG. 20). The secondary transfer power supply 86 automatically controls output voltage so that a transfer current of +40 to 60 μA is supplied, for example. The secondary transfer power supply 86 applies secondary transfer bias of positive polarity to the secondary transfer outer roller 131, and toner image born on the intermediate transfer belt 44b is secondarily transferred to the sheet S2 on the secondary transfer belt 85. The sheet S2 is attracted to the secondary transfer belt 85 by electrostatic force supplied from the secondary transfer power supply 86 accompanying secondary transfer of toner image. The conveyance surface formation roller 82 also serves as a separation roller. After reaching the conveyance surface formation roller 82, the sheet S2 on the secondary transfer belt 85 is curvature-separated from the secondary transfer belt 85 at a curved surface of the secondary transfer belt 85 arranged along the circumferential surface of the conveyance surface formation roller 82.

A sheet guide mechanism 6 that guides the sheet S2 conveyed from the registration roller pair 4 toward the secondary transfer portion 30 is provided between the registration roller pair 4 and the secondary transfer portion 130. The sheet guide mechanism 6 according to the present embodiment only differs from that of the first embodiment in that the sheet conveyance direction Ds is different, and the components are the same, so that the same reference numbers are assigned to the same components and detailed descriptions thereof are omitted.

Also according to the image forming apparatus 101 of the present embodiment, in the thick paper mode, the control unit 3 positions the outer downstream guide 72 to the first position before the sheet S2 conveyed by the registration roller pair 4 abuts against the inner downstream guide 62. Further, after the conveyed sheet S2 has been abutted against the inner downstream guide 62 and before the sheet S2 reaches the transfer nip portion 133, the control unit 3 moves the outer downstream guide 72 from the first position to the second position. Thereby, the speed reduction, i.e., impact, caused when the downstream edge portion St of the sheet S2 enters the transfer nip portion 133 can be reduced, and conveyance load can be minimized. Therefore, occurrence of impact and conveyance resistance of the intermediate transfer belt 44b and the transfer nip portion 133 can both be suppressed when conveying high stiffness sheets S2 such as thick paper.

Further according to the image forming apparatus 101 of the present embodiment, occurrence of impact at the transfer nip portion 133 formed by the intermediate transfer belt 44b and the secondary transfer belt 85 can be suppressed. Therefore, speed reduction and increase of conveyance load of not only the intermediate transfer belt 44b but also the secondary transfer belt 85 can be suppressed, and occurrence of impact and conveyance resistance can both be suppressed even in the secondary transfer belt 85.

### Other Embodiments

The second embodiment has illustrated a case where the inner downstream guide 62 is not provided, and the third embodiment has illustrated a case where a horizontal path system is adopted in which the sheets are conveyed approximately horizontally in the secondary transfer portion 130, but these embodiments can also be combined.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-060696, filed Mar. 27, 2018, which is hereby incorporated by reference herein in its entirety.

What is claimed is:

1. An image forming apparatus comprising:
a rotatable belt member configured to bear a toner image;
a first stretch roller configured to stretch the belt member;
a second stretch roller configured to stretch the belt member at a position adjacent to the first stretch roller on an upstream side in a direction of rotation of the belt member;
a rotary member that is in contact with an outer circumferential surface of the belt member, the rotary member configured to nip the belt member with the first stretch roller and form a transfer nip portion where toner image is transferred from the belt member to a recording material while conveying the recording material between the belt member and the rotary member;
a conveyance roller that is arranged upstream of the transfer nip portion in a conveyance direction of the recording material, the conveyance roller configured to form a conveyance nip portion that conveys the recording material and delivers the recording material to the transfer nip portion;
a pressing member positioned upstream of the transfer nip portion in the conveyance direction and downstream of the conveyance nip portion in the conveyance direction, the pressing member configured to move between a first position and a second position, the second position at which the pressing member projects to a conveyance path of the recording material than the first position and presses a first surface of the recording material opposed to a second surface of the recording material facing the belt member;
a driving source configured to drive the pressing member; and
a control unit configured to control the driving source,
wherein the control unit controls the driving source such that the pressing member is positioned at the first position in case that a basis weight of the recording material conveyed to the transfer nip portion is equal to or smaller than a predetermined value and the pressing member is positioned at the second position in case that the basis weight of the recording material conveyed to the transfer nip portion is greater than the predetermined value.

2. The image forming apparatus according to claim 1, wherein in case that the basis weight of the recording material conveyed to the transfer nip portion is greater than the predetermined value, the control unit controls the driving source such that the pressing member is positioned at the second position after a leading edge portion of the recording material in the conveyance direction has passed an opposing position which the pressing member opposes and before the leading edge portion reaches the transfer nip portion.

3. The image forming apparatus according to claim 1, wherein the pressing member is configured not to press the belt member in a case where the pressing member is positioned at the second position.

4. The image forming apparatus according to claim 1, wherein in case that the pressing member is positioned at the first position, a distance between the pressing member and the second stretch roller is a first distance, and in case that the pressing member is positioned at the second position, the distance between the pressing member and the second stretch roller is a second distance that is shorter than the first distance.

5. The image forming apparatus according to claim 1, wherein the pressing member is a swing member swingable about a swing shaft disposed along a rotational axis direction of the conveyance roller, and the pressing member is configured to move to the first position and the second position by swinging.

6. The image forming apparatus according to claim 5, wherein the driving source comprises a cam configured to swing the swing member and a motor configured to drive the cam.

7. The image forming apparatus according to claim 1, further comprising a guide member disposed upstream of the transfer nip portion and downstream of the conveyance nip portion in the conveyance direction, the guide member configured to guide the recording material to the belt member after the second surface of the recording material abuts against the guide member.

8. The image forming apparatus according to claim 7, wherein the guide member is configured to guide the recording material to a stretched portion of the belt member stretched between the first stretch roller and the second stretch roller.

9. The image forming apparatus according to claim 1, wherein the recording material conveyed from the conveyance nip portion abuts against the belt member without having a surface of the recording material opposed to the belt member being guided.

10. The image forming apparatus according to claim 9, wherein a leading edge portion of the recording material in the conveyance direction conveyed from the conveyance nip portion abuts against a stretched portion of the belt member stretched between the first stretch roller and the second stretch roller.

11. The image forming apparatus according to claim 1, wherein the conveyance roller is configured to convey the recording material upward in a vertical direction, and when viewed from a rotational axis direction of the conveyance roller, a direction of a nip line at the conveyance nip portion toward a downstream side in the conveyance direction is inclined with respect to the vertical direction toward a side where the belt member is arranged, and a direction of a nip line at the transfer nip portion toward the downstream side in the conveyance direction is inclined with respect to the vertical direction toward a side where the belt member is not arranged.

12. The image forming apparatus according to claim 1, wherein the first stretch roller is arranged above the second stretch roller.

13. The image forming apparatus according to claim 12, wherein the first stretch roller is arranged at a position projected larger than the second stretch roller with respect to a direction in which the first stretch roller presses the belt member horizontally.

14. The image forming apparatus according to claim 1, wherein the first stretch roller is arranged below the second stretch roller.

15. The image forming apparatus according to claim 14, wherein the second stretch roller is arranged at a position projected larger than the first stretch roller with respect to a direction in which the second stretch roller presses the belt member horizontally.

16. The image forming apparatus according to claim 1,
wherein the belt member is an intermediate transfer belt to which toner image is transferred from an image bearing member bearing the toner image, and
wherein the rotary member is a roller.

17. The image forming apparatus according to claim 1, further comprising
a roller configured to rotate,
wherein the belt member is a first belt member,
the rotary member is a second belt member, and
the roller is arranged on an inner circumferential side of the second belt member, and the roller is configured to nip the first belt member and the second belt member with the first stretch roller.

18. The image forming apparatus according to claim 17,
wherein the first belt member is an intermediate transfer belt to which toner image is transferred from an image bearing member bearing the toner image.
